(19) United States
(12) Patent Application Publication
(10) Pub. No.: US 2006/0066609 A1
(43) Pub. Date: Mar. 30, 2006

(54) Methods and systems for viewing geometry of an object model generated by a CAD tool

(76) Inventors: Arthur P. Iodice, Issaquah, WA (US); Charles M. Gingrich, Issaquah, WA (US); Paul McGoey, Kent, WA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/006,262

(22) Filed: Dec. 7, 2004

Related U.S. Application Data
(60) Provisional application No. 60/614,106, filed on Sep. 28, 2004.

(51) Int. Cl. G06T 15/00

(52) U.S. Cl. 345/419

(57) ABSTRACT

A system for remotely viewing geometry of an object model generated by a CAD tool hosted on a server computer on a network. The system has an image viewer accessible via a client computer on the network and an image server operatively connected between the image viewer and the CAD tool. The system receives an object model selection, provides the CAD tool with an ICAD application associated with the selection, commands the CAD tool to generate an object model having one or more elements using the ICAD application, displays on the client computer a structure identifying the one or more elements, receives a request to view a selected element, commands the CAD tool to generate an image file describing geometry of the selected element in response to the request, and displays the geometry of the selected element on the client computer in accordance with the image file.

### BACKGROUND OF THE INVENTION

The present invention relates to computer graphics, and more particularly, to methods and systems for viewing three-dimensional (3-D) geometry of an object model generated by a computer aided design (CAD) tool.

Engineers use conventional CAD applications or systems to design and visualize an object, such as a building, a car, an airplane (and its respective components or elements), in three dimensions (3-D). The CAD systems often use hundreds of thousands of polygons (e.g., triangles in a three-vector coordinate system) to represent the geometry of the object, such as surfaces, volumes, or elements of the object, in 3-D scenes for display on a video terminal. The 3-D scenes typically are generated using multiple two-dimensional computer images representing a corresponding portion of the geometry of the object and together reflect a cubic volume of the object. CAD systems often allow the user to change his viewpoint or change the geometry in real time, requiring the CAD system to render new 3-D scenes of the object on the fly in real time. As a result, CAD applications commonly are hosted on high-speed graphic work stations (such as workstation-class computers available from Sun Microsystems, Inc. or Silicon Graphics, Inc., or PC-type computers with exceptional amounts of memory or high-end graphics cards) to enable the CAD applications to process very large amounts of data for generating and displaying the 3-D scenes within a rapid response time.

But high-speed graphic work stations often are expensive and generally not purchased by a user for project employees other than design engineers. Thus, for collaborative engineering designs, engineers each must have or share high-speed graphic work stations with a direct link to the geometry database where the collaborative CAD design application or model of the object is stored. In addition, for project reviews and other events, engineers use static reproductions of the 3-D scenes to share design information with others (e.g., customers). This limits the design review activity to small meetings where reviewers are brought to the computing machinery to view the design information.

Therefore, a need exists for systems and methods that overcome the problems noted above and others previously experienced for producing and viewing on a low-end machine geometry of an object generated by a CAD system or other legacy graphic image generator.

### SUMMARY OF THE INVENTION

Methods, systems, and articles of manufacture consistent with the present invention allow one or more users on respective client computer systems on a network to collaboratively view, manipulate, redline, and measure geometry of an object model generated by a computer-aided design (CAD) tool hosted on a server computer system on the network.

In accordance with systems consistent with the present invention, a data processing system is provided. The data processing system comprises: a plurality of client computer systems operatively connected to a network, a first server computer system operatively connected to the network and having a first CAD tool, means for receiving, via a first of the client computer systems, an object model selection associated with the first CAD tool, means for providing the first CAD tool with an ICAD application associated with the object model selection, means for commanding the first CAD tool to generate an object model using the ICAD application, the object model having one or more elements, means for displaying, on the first client computer system, a structure identifying the one or more elements of the object model, means for receiving a request, via the first client computer system, to view a selected one of the elements, means for commanding the first CAD tool to generate an image file describing geometry of the selected element in response to the request to view the selected element, and means for displaying the geometry of the selected element on the first client computer system in accordance with the image file.

In accordance with systems consistent with the present invention, a data processing system is provided that includes a plurality of client computer systems operatively connected to a network. Each client computer system has an image viewer. The data processing system also includes a first server computer system operatively connected to the network. The first server computer system has a first CAD tool. The data processing system further includes a memory that has an image server program operatively connected, via the network, to the image viewer on each of the plurality of client computer systems and to the first CAD tool. The image server program receives, via a first of the client computer systems, an object model selection associated with the first CAD tool, provides the first CAD tool with an ICAD application stored on the network and associated with the object model selection, commands the first CAD tool to generate an object model having one or more elements using the ICAD application, provides the image viewer on each of the client computer systems with a structure identifying the one or more elements of the object model, receives a request, via the first client computer system, to view a selected one of the elements, commands the first CAD tool to generate an image file describing geometry of the selected element in response to the request to view the selected element, and causes the image viewer on each of the client computer systems to display the geometry of the selected element on the client computer system in accordance with the image file. The data processing system also includes a processor to run the image server program.

In accordance with articles of manufacture consistent with the present invention, a computer-readable medium containing instructions causing a program in a data processing system to perform a method is provided. The data processing system has a plurality of client computer systems operatively connected to a network and a server computer system operatively connected to the network and having a CAD tool. The method comprises: receiving, via a first of the client computer systems, an object model selection associated with the first CAD tool, providing the first CAD tool with an ICAD application associated with the object model selection, commanding the first CAD tool to generate an object model using the ICAD application, the object model having one or more elements, receiving a structure identifying the one or more elements of the object model, providing the structure to at least the first client computer system, receiving a request to view a selected one of the elements, commanding the first CAD tool to generate an image file describing geometry of the selected element in response to the request to view the selected element, and providing one of the image file or a representative object model generated from the image file to each of the client computer systems so that each client computer system displays the geometry of the selected element in accordance with the image file.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts a block diagram of a data processing system suitable for viewing geometry of an object model generated by one of multiple CAD tools across a network consistent with the present invention;

FIGS. 2A-2K depict a flow diagram illustrating steps in a process for remotely controlling a first CAD tool via an image server in the data processing system to generate and view geometry of the object model;

FIG. 3 depicts an exemplary user interface generated by the image viewer on a client computer system in the data processing system to receive information from a user seeking access to the image viewer;

FIG. 4 depicts an exemplary user interface generated by the image viewer, where the user interface provides an option for joining an existing session managed to collaborate in a CAD environment, including allowing each network user to view geometry of the object model;

FIG. 5 depicts an exemplary user interface generated by the image viewer, where the user interface provides a tag for each CAD tool supported by the image server in accordance with systems and methods consistent with the present invention;

FIG. 6 depicts an exemplary user interface generated by the image viewer, where the user interface provides selections corresponding to CAD Applications associated with the first CAD tool in the data processing system;

FIG. 7 depicts an exemplary configuration file associated with a respective CAD application that may be retrieved by the image server and loaded on the first CAD tool to generate an object model of an application part;

FIG. 8 depicts an exemplary user interface generated by the image viewer to allow users to change a default value for an input element identified in the configuration file in FIG. 7 and used to generate the object model of the application part;

FIG. 9 depicts an exemplary user interface generated by the image viewer to display progress of the first CAD tool in loading the selected CAD application used to generate the object model of the application part;

FIG. 10 depicts an exemplary user interface generated by the image viewer to display elements that define the application part object model generated by the first CAD tool;

FIG. 11 depicts an exemplary user interface generated by the image viewer to allow users to selectively request to view geometry of the application part object model or one of its elements;

FIG. 12 depicts an exemplary user interface generated by the image viewer to display a list of one or more object models generated by the second CAD tool, where a user is able to selectively request to view and manipulate geometry of an object model identified in the list;

FIG. 13 depicts an exemplary user interface generated by the image viewer to allow users to hide previously displayed geometry of the object model in FIG. 12;

FIG. 14 depicts an exemplary user interface generated by the image viewer to allow users to rotate previously displayed geometry of the object model in FIG. 12;

FIG. 15 depicts an exemplary user interface generated by the image viewer to allow users to selectively create a mark-up of the geometry of an application part object model generated by the first CAD tool;

FIG. 16 depicts an exemplary user interface generated by the image viewer to allow users to selectively create a markup of the geometry of an object model generated by either the first CAD tool, the second CAD tool, or both;

FIG. 17 depicts an exemplary user interface generated by the image viewer to allow users to hide a previously displayed markup of the geometry of the object model;

FIG. 18 depicts an exemplary user interface generated by the image viewer to allow users to selectively redline geometry of an application part object model generated by the first CAD tool;

FIG. 19 depicts an exemplary user interface generated by the image viewer to allow users to selectively create a mark up of the geometry of an object model generated by either the first CAD tool, the second CAD tool, or both;

FIG. 20 depicts an exemplary user interface generated by the image viewer to allow users to selectively make a measurement of geometry of an application part object model generated by the first CAD tool;

FIG. 21 depicts an exemplary user interface generated by the image viewer to allow users to selectively make a measurement between a first point associated with geometry of an object model generated by the first CAD tool and a second point associated with geometry of another object model generated by the second CAD tool, or both; and

FIGS. 22-24 depict an exemplary user interface generated by the image viewer to allow users to create and rotate a cross section of an object model generated by either the first or second CAD tool.

### DETAILED DESCRIPTION OF THE PREFERRED EMBODIMENT

Reference now will be made in detail to an implementation in accordance with methods, systems, and products consistent with the present invention as illustrated in the accompanying drawings. The same reference numbers may be used throughout the drawings and the following description to refer to the same or like parts.

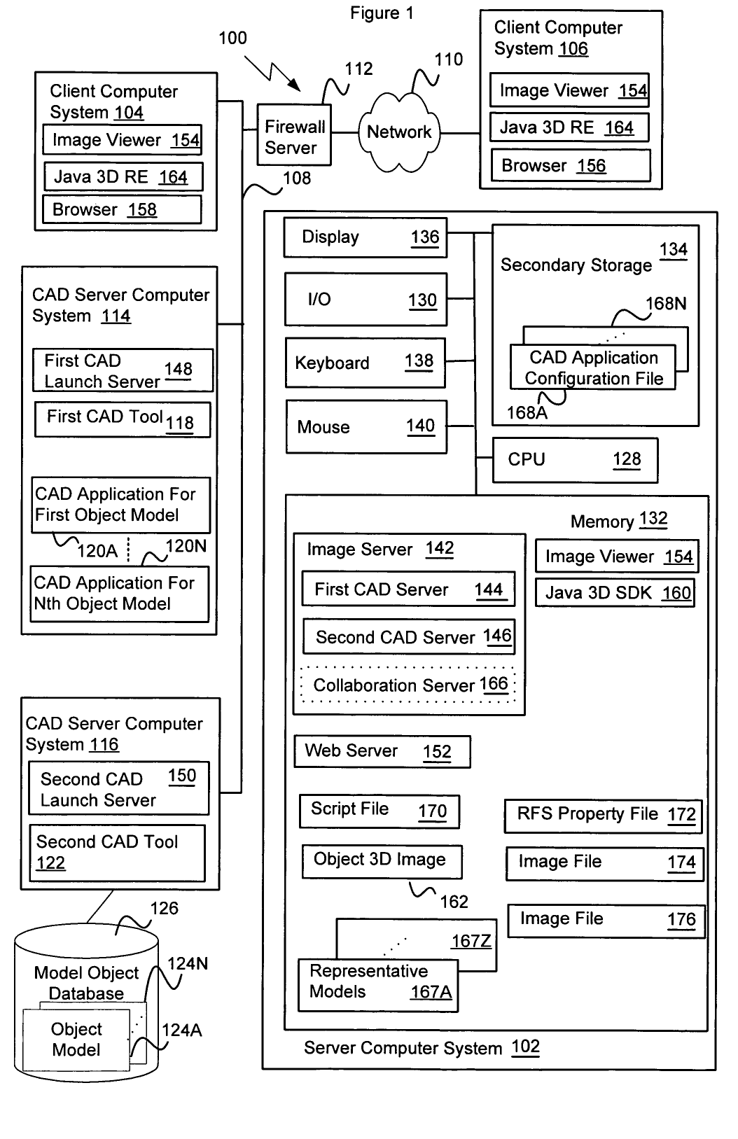

FIG. 1 depicts a block diagram of a data processing system 100 suitable for allowing a user to remotely view, alone or collaboratively with other users, geometry of an object model generated by a CAD tool consistent with the present invention. The data processing system 100 includes a server computer system 102 and one or more client computer systems 104 and 106. In the implementation shown in FIG. 1, the server computer system 102 is operatively connected to the first client computer system 104 via an internal network 108 and to the second client computer system 106 via an external network 110 and a commercially available firewall server 112. The server computer system 102 and the client computer systems 106 and 108 may be any general-purpose computer system such as an IBM compatible (based on a Windows or Unix operating system), Apple, or other equivalent computer.

The networks 108 and 110 may be any known communication network, such as a local area network (“LAN”), WAN, or Peer-to-Peer, using standard communications protocols. The external network 110 may be the Internet. The networks 108 and 110 may include hardwired, as well as wireless branches.

The data processing system 100 also includes one or more CAD server computer systems 114 and 116 operatively connected to the server computer system 102 via the network 106. In the implementation shown in FIG. 1, the first CAD server computer system 114 hosts a first CAD tool 118, such as ICAD 8.1 commercially available from Knowledge Technologies International, that allows an engineer to develop a CAD software program or application (e.g., CAD Application 120A) for generating a geometric model (not shown in FIG. 1) of an object based on a set of engineering rules related to the design and manufacturing of the object. The first CAD server computer system 114 may be any general-purpose computer system like server computer system 102. Alternatively, for increased processing speed for controlling the CAD Tool 118, the first CAD server computer system 114 may be a workstation-class computer available from Sun Microsystems, Inc. or Silicon Graphics, Inc. For brevity in the description and understanding the present invention, assume that an engineer previously developed CAD Applications 120A-120N for a first object through an Nth object using the first CAD tool 118 while operating on the first CAD server computer system 114.

The second CAD server computer system 116 hosts a second CAD tool 122 that is an integrated suite of CAD, computer-aided engineering (“CAE”), and computer-aided manufacturing (CAM”) applications, such as the commercially-available “CATIA” application from Dassault Systems and “UNIGRAPHICS” available from Unigraphics Solutions, Inc. of Cypress, Calif. The second CAD tool 122 allows the user to develop a 3-D photo-realistic product definition of an object's geometry through development of a corresponding object model 124A-124N, known as a “solid model.” The object model generated by the first CAD tool 118 using a respective CAD Application 120A-120N may be translated by the first CAD tool 118 in a format corresponding to the object model (e.g., object model 124A) using known translation techniques, such as the technique supported by ICAD 8.1 for translating an ICAD object model format to a CATIA V5 object model format.

When hosting the second CAD tool 122, the second CAD server computer system 116 is preferably a workstation-class computer available from Sun Microsystems, Silicon Graphics, or other vendors. In this implementation, the second CAD server computer system 116 may be operatively connected to a model object database 126 to store the object model 124A-124N. The model object database 126 may be incorporated in a separate general-purpose computer system having a known remote file server (RFS) for accessing the object model 124A or 124N.

As discussed in detail, the server computer system 102 is operatively configured to allow users using client computer system 104 or 106 to view, alone or in collaboration with other affiliates using another client computer system 106 or 104, geometry of an object model generated by the first CAD tool 118 using a selected CAD application 120A-120N or geometry of a selected object model 124A-124N generated by the second CAD tool 122.

As shown in FIG. 1, server computer system 102 comprises a central processing unit (CPU) 128, an input output I/O unit 130, a memory 132, a secondary storage device 134, and a display 136. Server computer system 102 may further comprise standard input devices such as a keyboard 138, a mouse 140, or speech processing means (not illustrated). The CPU 128 may be a low-end processor, such as an Intel Pentium II™ processor having a processing speed as low as about 400 MHz. These various components of a server computer system 102 may be physically located remotely from each other and connected via the network 106. Although not shown for brevity, client computer systems 104 and 106 also comprise components 128, 130, 132, 134, 136, and standard input devices (e.g., keyboard 138 and mouse 140).

Memory 108 of the server computer system 102 stores an image server 142 program including a first CAD server 144 and a second CAD server 146 operatively configured to communicate across the network 108 with the first CAD tool 118 and the second CAD tool 122, respectively. In one implementation, the first CAD server 144 is configured to communicate with the first CAD server 144 using known application program interface (API) commands for the first CAD server 144 (e.g., known API commands for interfacing with an ICAD system). The second CAD server 146 similarly may be configured for communicating with the second CAD server 144. Alternatively, to expedite communication across the network 108 to the first CAD tool 118, the first CAD server's 144 functionality for communicating directly with the first CAD tool 118 may be incorporated into a first CAD launch server 148 hosted on CAD server computer system 114. Similarly, the second CAD server's 146 functionality for communicating directly with the second CAD tool 118 may be incorporated into a second CAD launch server 150 hosted on CAD server computer system 116. In this implementation, the CAD launch server 148 is configured to cause the first CAD tool 118 to launch and manage running CAD application 120A-120N in response to corresponding directives sent by the CAD Server 144. The CAD launch server 150 is configured to cause the second CAD tool 118 to launch and load in response to corresponding directives sent by the CAD Server 144.

Memory 132 of the server computer system 102 also may include a web server 184, such as Tomcat 4.1 available from the Apache Software Foundation, and an image viewer 170 that may be accessed as a servlet via the web server 184. The image viewer 170 provides a graphical user interface (GUI) for communicating with the image server 142. Client computers 104 and 106 each include a browser 156, 158 to access or upload the image viewer 170. The browsers 156 and 158 may be any standard browser, such as Netscape™ or Internet Explorer™.

Memory 132 of server computer system 102 also may include Java 3-D SDK 160 software from Sun Microsystems, Inc. or other equivalent 3-D support tool to enable the image server 142 to build, render, and control the behavior of a 3-D object image 162 generated in accordance with methods consistent with the present invention for display using image viewer 154. Client computer systems 104 and 106 may include a Java 3-D Runtime Environment or other equivalent that is operatively configured to respond to Java 3-D API commands from the image viewer 154 for rendering and manipulating the 3-D object image 162 provided via the image server 142.

In one implementation, image server 142 also includes a collaboration server 166, such as Collab View™ commercially available from Geometric Software Solutions, enabling the image server 142 to manage collaborative viewing of geometry (e.g., object 3-D image 162) of an object model generated by the first CAD tool or the second CAD tool. In one implementation, the image server 142 maintains a representative copy (e.g., model 167A-167Z) of each object model generated by the first CAD tool and the second CAD tool to facilitate manipulation and collaborative viewing of geometry of the representative model 167A-167Z individually or in multiples.

In accordance with systems and methods consistent with the present invention, the image server allows users using the image viewer 154 on client computer system 104 or 106 to select a configuration file 168A-168N associated with a respective CAD application 120A-120N and to modify an element in the selected configuration file so that the first CAD tool 118 generates an object model using the respective CAD application 120A-120N and reflecting the modified element. In the implementation shown in FIG. 1, the configuration files 168A-168N are stored in secondary storage 134 on server computer system 102. Alternatively, the configuration files 168A-168N may be stored on CAD Server Computer System 114, Client Computer Systems 104 and 106, or other computer systems in the data processing system 100.

In addition, although aspects of one implementation shown in FIG. 1 are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of data processing system 100 have been described, a data processing system suitable for use with methods, systems, and articles of manufacture consistent with the present invention may contain additional or different components.

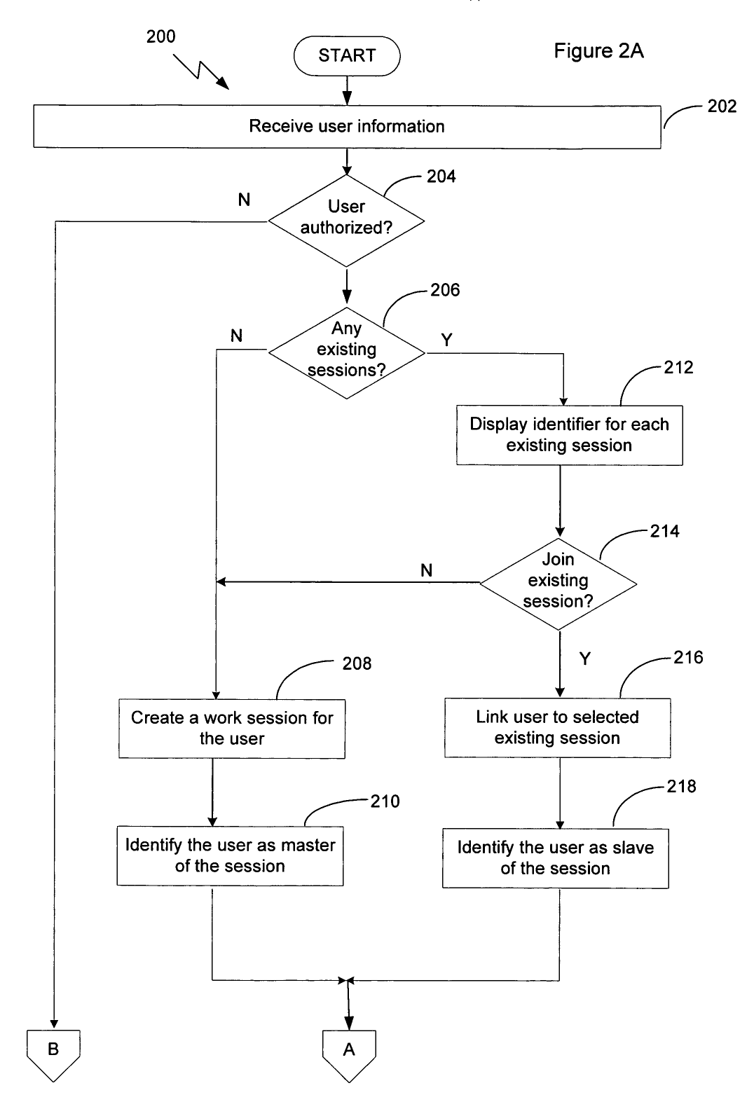

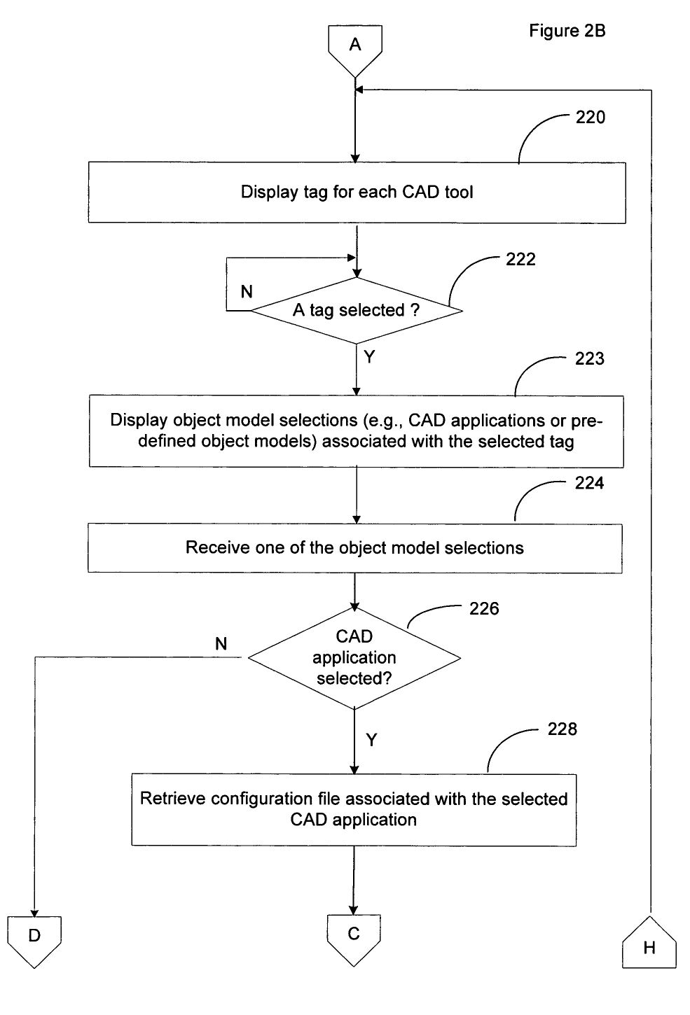

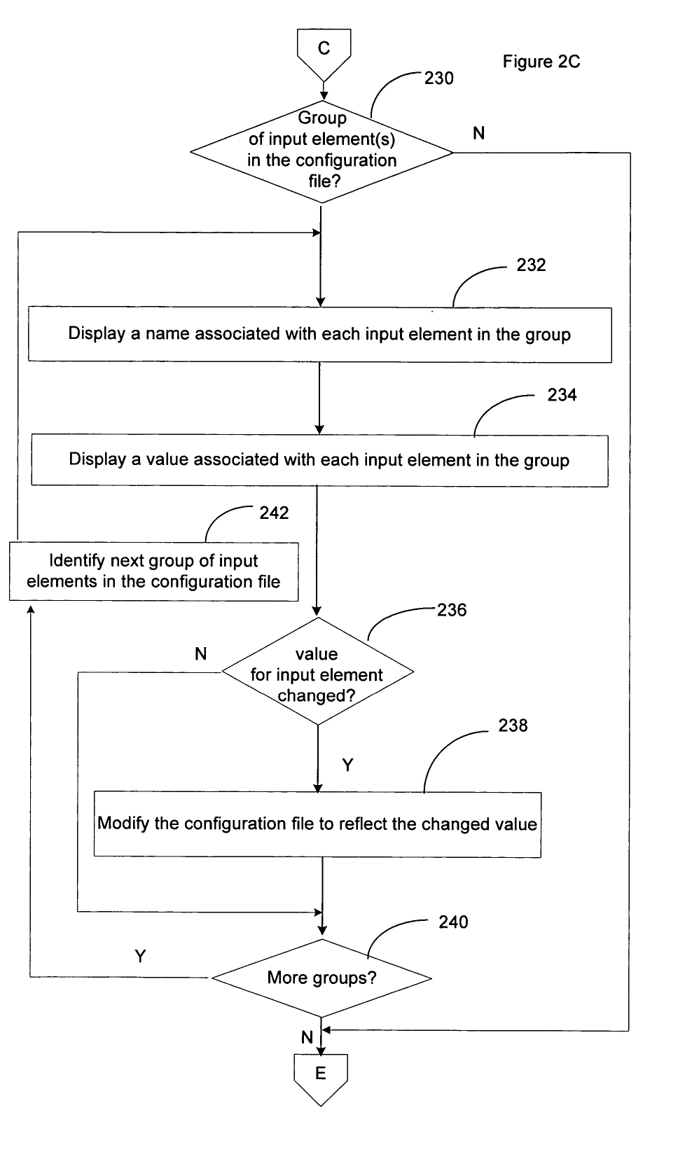

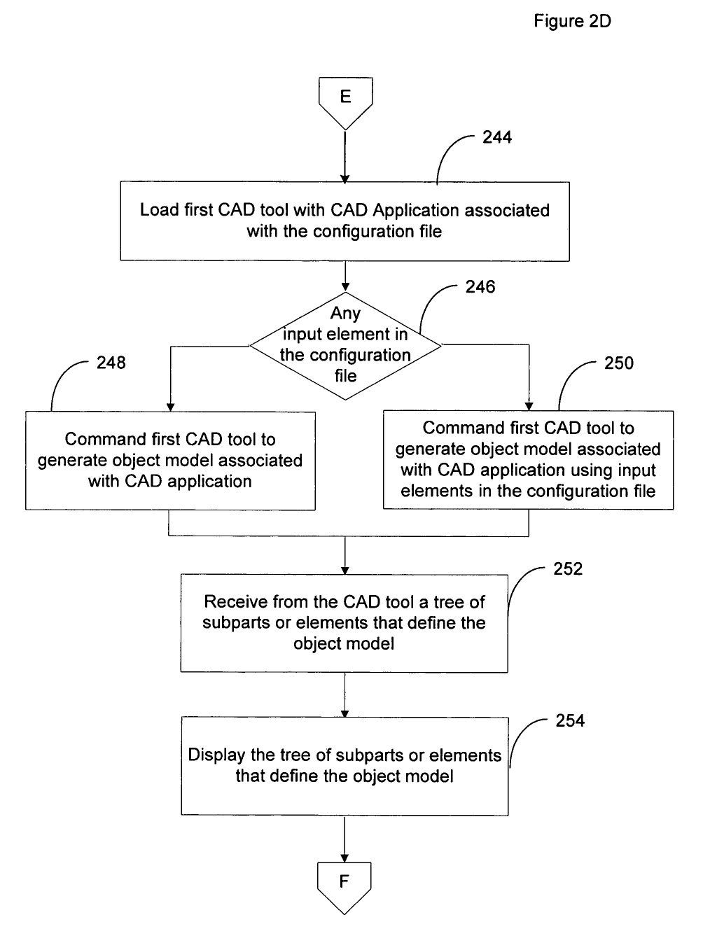

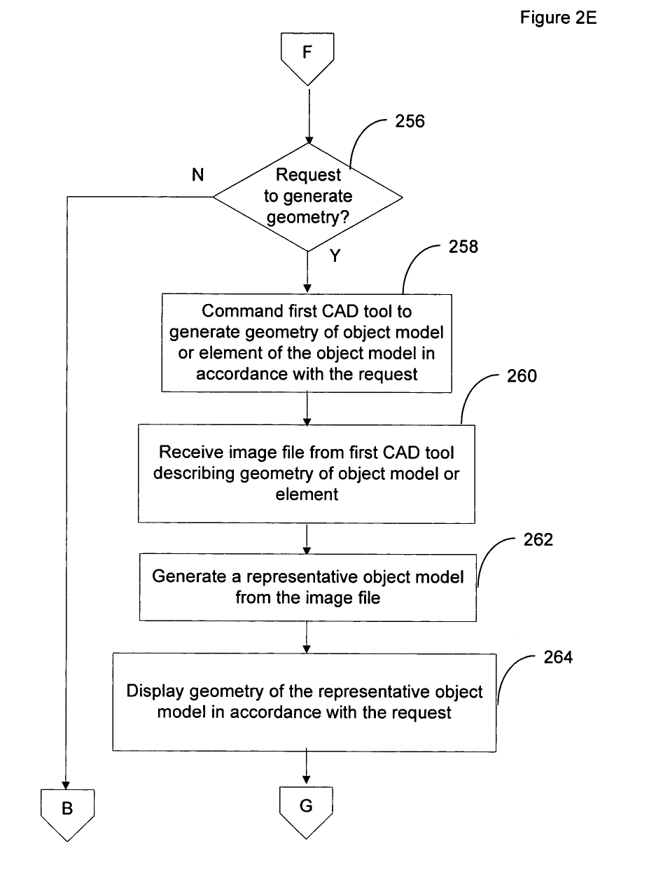

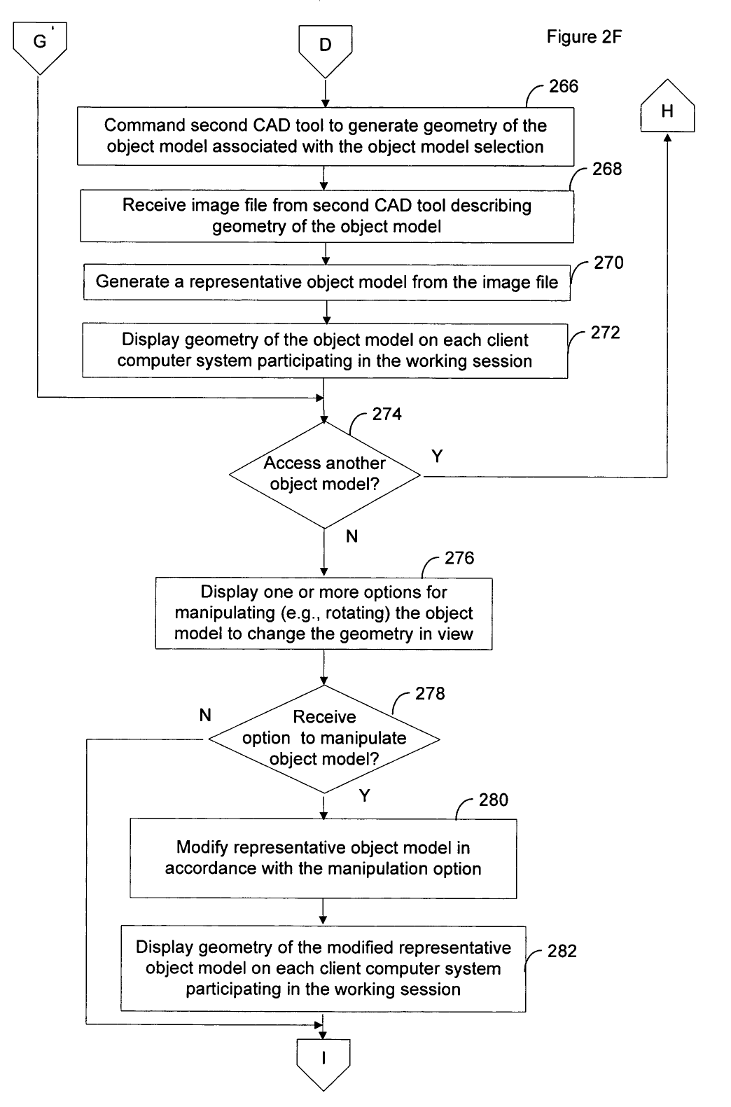

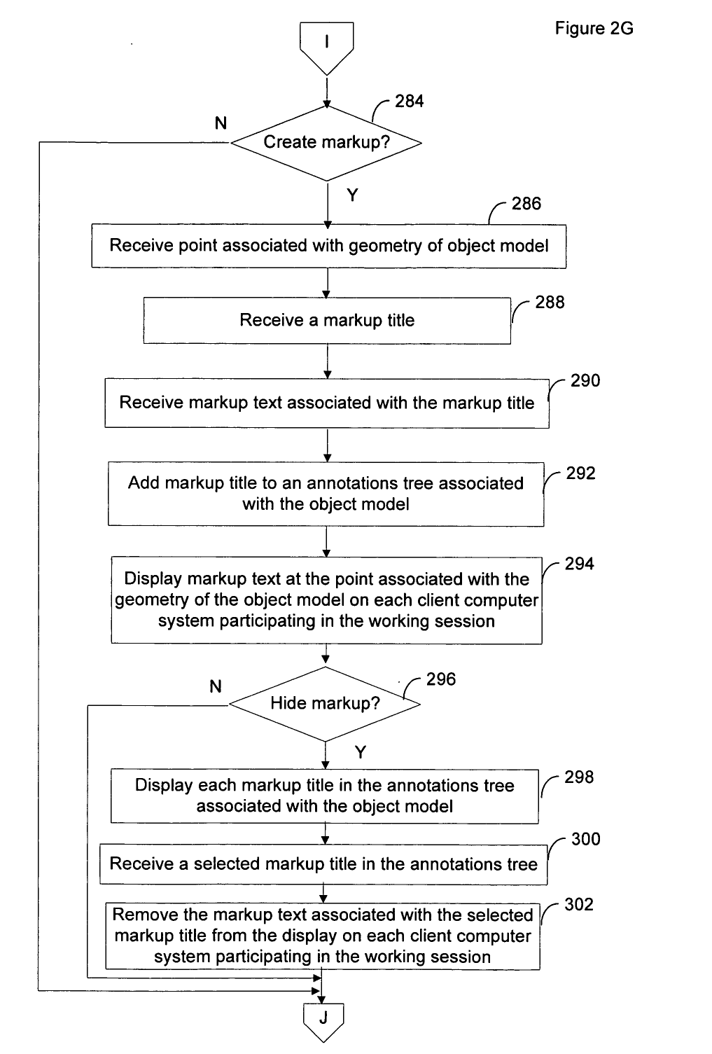

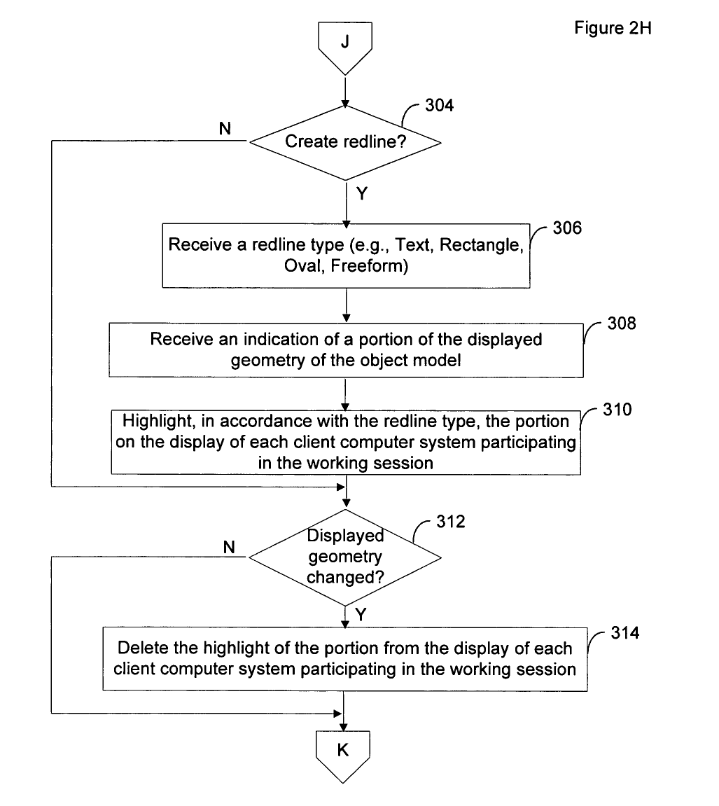

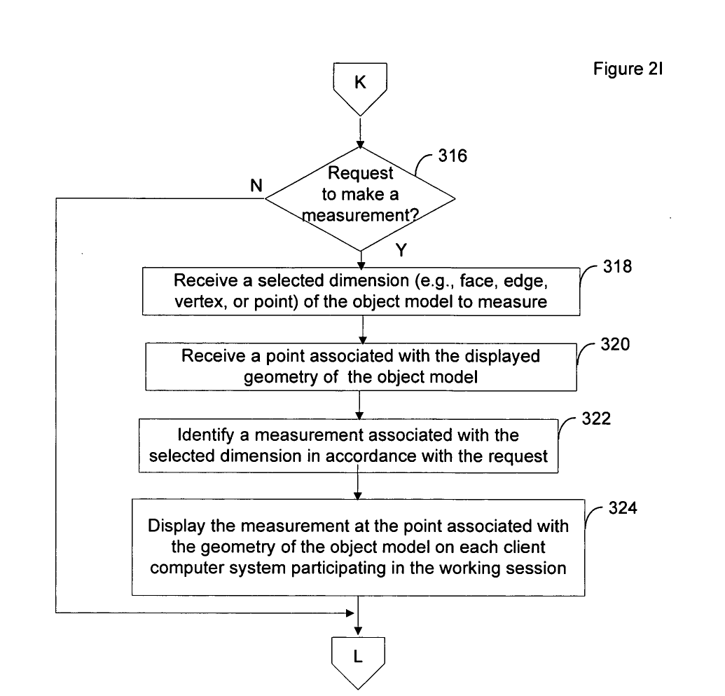

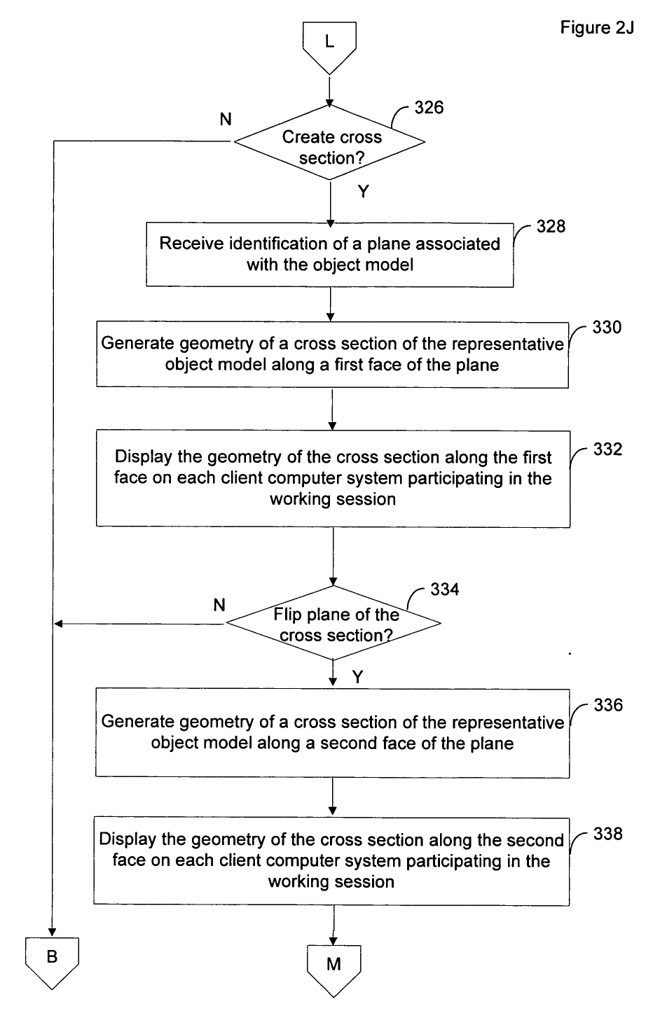

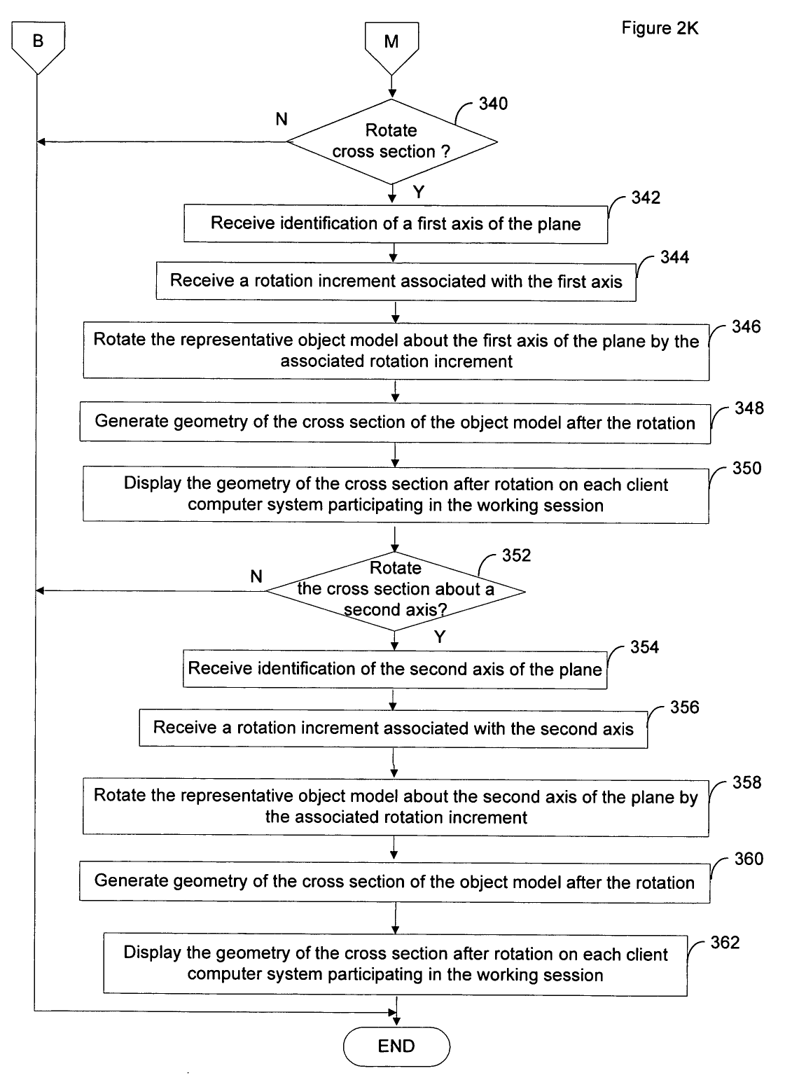

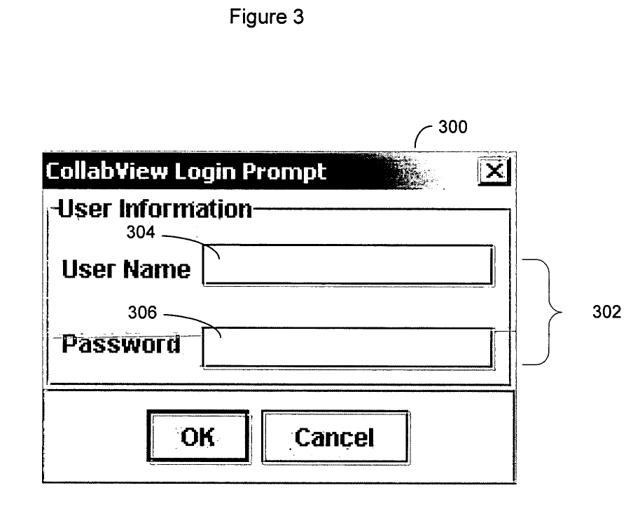

FIGS. 2A-2E depict a flow diagram illustrating steps in a process 200 for remotely controlling one or more CAD tools 114 and 116 in the data processing system 100 to generate and view geometry of an object model generated by the respective CAD tool. Users operating on the client computer system 104 or 106 may initiate the process 200 by launching the image viewer 154 via the respective browser 158 or 156. The user's affiliate may launch the image viewer 154 by providing the URL address (not shown in figures) of the image viewer 154 to the browser 158 or 156 to cause the web server 152 to upload or allow access to the image viewer 154 on the server computer system 102. After the image viewer 154 is launched on the client computer system 104 or 106, the image viewer 154 receives user information from the user (step 202). In the implementation shown in FIG. 3, the image viewer 154 generates a logon screen 300 to receive user information 302 from the user. The user information may include a user name 304 and a password 306.

After receiving the user information 302, the image viewer 154 determines whether the user is authorized to access a object model generated by CAD tools (e.g., CAD tools 118 and 122) controlled by the image server (step 204). The image viewer 154 may determine that the user is authorized for access by using standard user authentication techniques, such as by verifying user information 302 is contained in a user profile (not shown in figures) stored on the server computer system 102 or other computer on network 108. Alternatively, the image viewer 154 may transfer the user information 302 to the image server 142 so that the image server 142 is able to determine if the user is authorized for access.

If the user is not authorized for access, the image viewer 154 ends processing. If the user is authorized for access, the image viewer 154 via the image server 142 determines whether there is an existing work session in which another user is using the image server 142 to view geometry of an object model generated by the CAD tool 118 or 122 (step 206). The image server 142 creates and manages, via the collaboration server, each work session for users authorized for access in step 204. Thus, image server 142 is able to inform the image viewer 154 of each existing work session currently being managed by the image server 142. If there is not an existing work session, the image server 142 creates a new work session for the user (step 208) and identifies the user as the master of the work session (step 210). In one implementation, the image server 142 sends the request to create a new work session to the CAD Launcher server 148 or 150 associated with the respective CAD tool 118 or 122 in accordance with the object model selection (e.g., CAD Application 120A or object model 124A) identified by the user as discussed in further detail below.

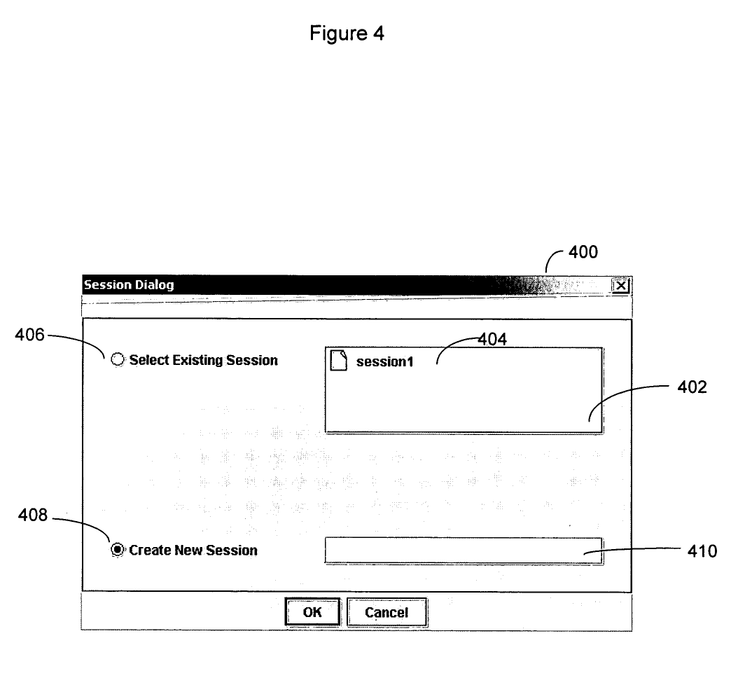

If there is an existing work session, the image viewer 154 displays an identifier for each existing session being managed by the image server with an option to join the respective existing session (step 212) and then determines whether the user has selected to join one of the existing work sessions (step 214). FIG. 4 depicts an exemplary user interface 400 generated by the image viewer 154 in which the image viewer displays each existing work session currently being managed by the image server 142 in a panel 402 of the user interface 400. As shown in FIG. 4, the image viewer 154 displays an identifier 404 in panel 402 for each existing work session (e.g., “session1”) currently being managed by the image server 142. The image viewer may also display a first option 406 on the user interface to join a selected one of the existing work sessions identified in panel 402, and a second option 408 to create a new work session. The identifier 402 may convey the name (e.g., user name 304 in FIG. 3) of the master of the respective work session or an identification of the CAD application 120A-120N or object model 124A-124N being accessed in the respective existing work session. Thus, the user may select to join one of the existing work sessions by selecting, via mouse click or keyboard input, the respective identifier 404 in panel 402.

If the user has selected not to join one of the existing work sessions, then the image viewer 154 continues processing at step 208 to create a new work session for the user. In the implementation shown in FIG. 4, the image viewer 154 allows the user to provide an identifier 410 for the new work session so that other affiliates using other client computer systems (e.g., client computer system 106) are able to easily identify and select the identifier 410 to join the new work session.

If the user has selected to join one of the existing work sessions, then the image viewer 154 via the image server 142 links the user to the selected existing work session (step 216) and identifies the user as a slave of the work session (step 218). Thus, the user operating on one client computer system (e.g., client computer system 104) may be linked as a slave by the image server 142 to the selected existing work session in which another user is operating on another client computer system (e.g., client computer system 106) and another instance of process 200 is being performed. The other instance of process 200 is performed by the web viewer 154 on the other client computer system 106 in conjunction with the image server 142. Although the next step shown in FIG. 2A for process 200 is step 220, the user operating on the one client computer system 104 may be linked to the existing work session while the other instance of process 200 is performing any step after step 218.

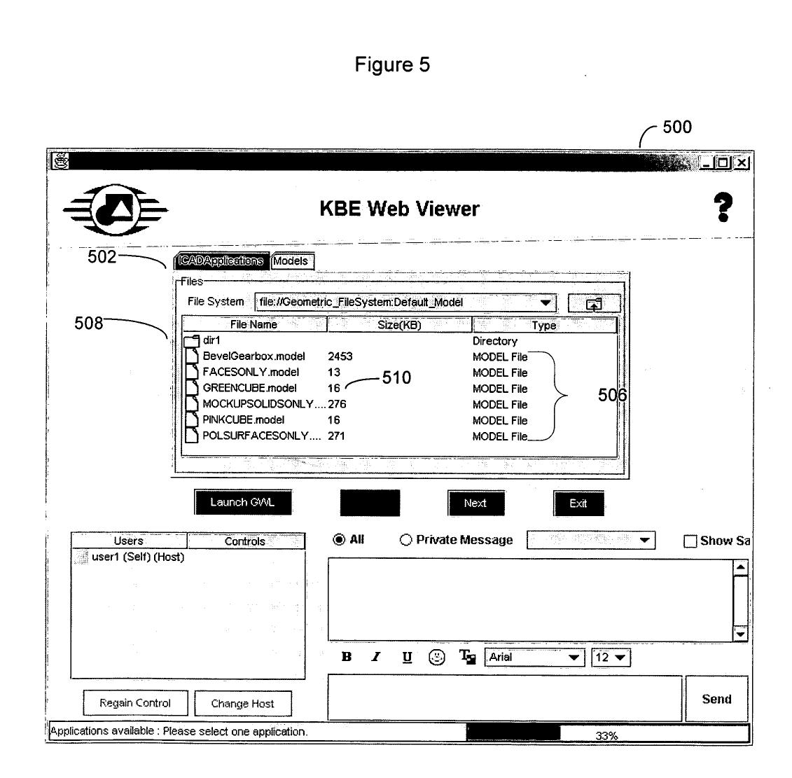

Turning to FIG. 2B, the image viewer 154 then displays a tag for each CAD tool supported by the image server (step 220) and determines whether any tag is selected (step 222). In the implementation shown in FIG. 5, the image viewer 154 generates user interface 500 in which tag 502 is displayed to identify the first CAD tool 118 and tag 504 is displayed to identify the second CAD tool 122. The user may then select one of the tags 502 or 504 via a mouse “click” or other input technique. Initially, the image viewer 154 may select one of the tags 502 or 504 by default.

If a tag is selected, the image viewer 154 displays object model selections (e.g., CAD applications 120A-120N or object models 124A-124N) associated with the selected tag (step 223). For example, when the tag 504 is selected as shown in FIG. 5, the image viewer 154 displays the object model selections 506 corresponding to object models 124A-124N created using the second CAD tool. In one implementation, image viewer 154 is able to identify the object models 124A-124N by querying the second CAD tool 122 via the image server 142 and second CAD launch server 150 for filenames of object models 124A-124N stored on the object model database 126. In the implementation in which the model object database 126 is incorporated in a separate general-purpose computer system having a known remote file server (RFS) for accessing the object model 124A-124N, the image server 142 retrieves from a RFS property file 172 and provides the image viewer 152 a network path where the object models 124A-124N are stored. In this implementation, the image server 142 is able to request a directory listing 508 to identify the object model selections 506.

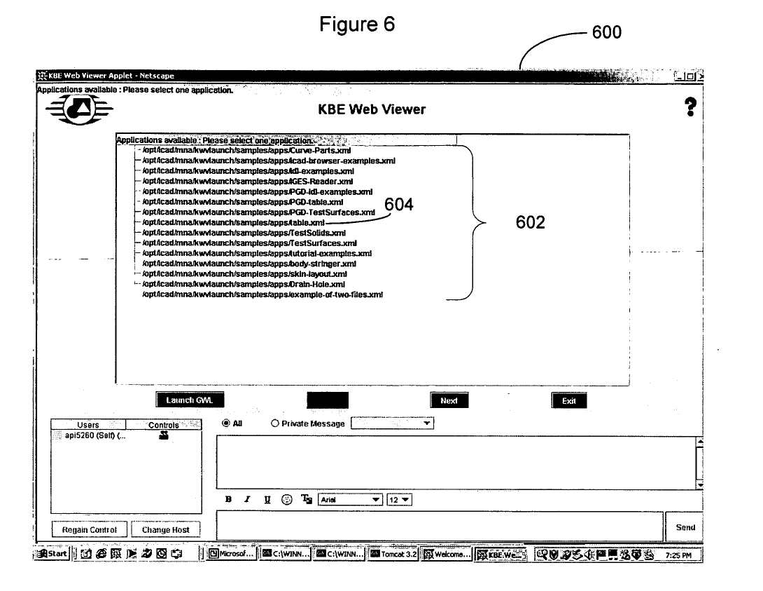

When the tag 502 is selected, the image viewer 142 displays the object model selections 602 on user interface 600 as depicted in FIG. 6, where the object model selections correspond to CAD Applications 120A-120N associated with the first CAD tool 118 in the data processing system. The image viewer 154 may identify the CAD Applications 120A-120N by querying the first CAD tool 118 via the image server 142 and the first CAD launch server 148 for filenames of object models 124A-124N stored on the object model database 126. Alternatively, the image server 142 may identify CAD Applications 120A-120N stored at a pre-defined network path (e.g., “/opt/icad/mna/kwvlaunch/samples/apps” as shown in FIG. 6).

Next, the image viewer 154 receives one of the object model selections (step 224). The user may use a mouse “click” or keyboard input to identify the one object model selection (e.g., 510 in FIG. 5 or 604 in FIG. 6) to the image viewer 154. The image viewer 154 then determines whether the object model selection corresponds to a CAD Application (step 226). When the selected tag is tag 502 corresponding to the first CAD tool 118, the image viewer 154 is able to recognize that the object model selection 604 corresponds to a CAD Application (e.g., CAD Application 120A). Similarly, when the selected tag is tag 504, the image viewer 154 is able to recognize that the object model selection 510 corresponds to an object model (e.g., object model 120A) generated by the second CAD tool 122.

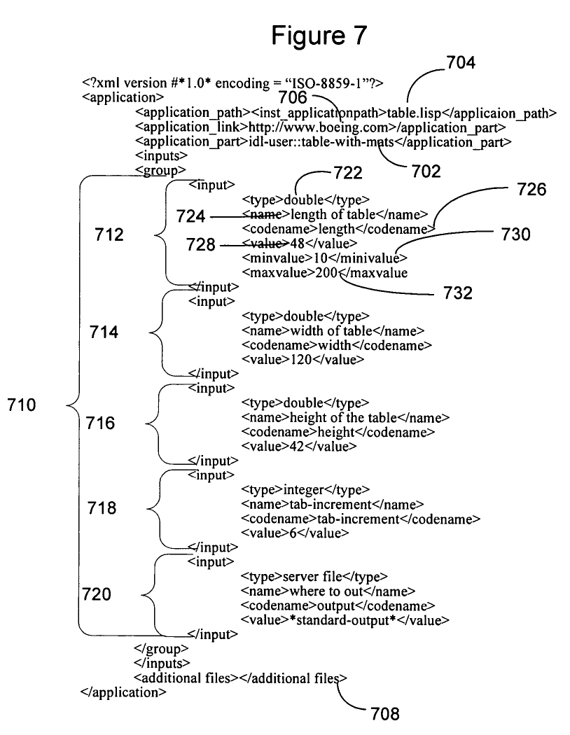

If the object model selection corresponds to a CAD Application, the image viewer 154 retrieves a configuration file associated with the selected CAD Application (step 228). In the implementation shown in FIG. 6, the object model selections 602 identify configuration files 168A-168N that are associated with respective CAD Applications 120A-120N. FIG. 7 depicts an exemplary configuration file 700 associated with CAD application 120A that may be requested by the image viewer 154 from the image server 142 when the object model selection 604 is chosen by the user. The image viewer 154 allows the user, acting as the master on the respective client computer system 104, to change an input element contained in the configuration file 700 to cause the first CAD tool 118 to generate a corresponding change in the geometry of the object model produced using the CAD Application 120A. The configuration file 700 may be configured using eXtensible Markup Language (XML), HyperText Markup Language (HTML), or other equivalent language for structuring a document for transfer between applications, such that the image viewer 152 and image server 142 are able to define, transmit, and interpret data for a CAD application 120A-120N across the network 108 or 110 in accordance with methods and systems consistent with the present invention.

As shown in FIG. 7, each configuration file 700 includes an “application part” 702 for identifying the object model or a part of the object model to be instantiated or generated by the first CAD tool 118 using the CAD application 120A associated with the configuration file 700 as further explained below. The image server 142 and image viewer 154 may identify the application part 702 in the configuration file 700 by searching for a first beginning delimiter, such as “<application_part>”, and a first end delimiter, such as “</application_part>.”

Each configuration file 700 also may include an “application path” 704 that identifies where the CAD application 120A corresponding to the object model selection 602 is stored on the network 108. The image server 142 and image viewer 154 may identify the application path 704 in the configuration file 700 by searching for a second beginning delimiter, such as “<application_path>”, and a second end delimiter, such as “</application_path>”.

The configuration file 700 may also include an “application link” 706 identifying the gateway link or uniform resource locator (e.g., web address) for accessing the CAD application 120A via the web server 152. A third beginning delimiter (e.g., “<application_link>”) and a third end delimiter (e.g., “</application_link>”) may be used to identify the application link 706 within the configuration file 700.

The configuration file 700 also may include one or more secondary configuration files or “additional files” 708 containing information required for the CAD Application 120A associated with the configuration file 700 to be loaded by the first CAD tool 118. Each of the additional files 708 may be demarcated by a fourth beginning delimiter (e.g., “<additional files>”) and a fourth end delimiter (e.g., “</additional files>”) recognizable by the image server 142 and the image viewer 154.

The configuration file 700 also may include a group 710 of one or more input elements 712, 714, 716, 718, and 720. Each input element 712, 714, 716, 718, and 720 identifies a dimension or element used by the first CAD tool 118 to generate the application part 702 or object model using the CAD application located at the application path 704. Each group 710 of input elements may be demarcated by a fifth beginning delimiter (e.g., “<group>”) and a fifth end delimiter (e.g., “</group”). Each input element 712, 714, 716, 718, and 720 within the group 710 may be demarcated by a sixth beginning delimiter and a sixth end delimiter (e.g., “<input>” and “</input>”, respectively), such that the image server 142 and the image viewer 154 are able to identify each group 710 and input elements within each group 710.

Each input element 712, 714, 716, 718, and 720 has an input type 722, an input name 724, and a value 728 of the input type 722 to be associated with the input name 724. Each input element 712, 714, 716, 718, and 720 also may have a code name 726, which may be substituted for the input name by the image viewer 154 or first CAD launcher server and understood by the first CAD tool 118 when referencing the respective input element, such as when commanded to generate geometry associated with the respective input element 712, 714, 716, 718, and 720. The input type 722 may be a double integer, integer, float, string, or other variable type. The input type may also be “server file” indicating to the image server 142 a file is to be associated with input name 724 and value 728. For example, input element 720 indicates to the image server 142 that a server file is too defined for “where to output” (e.g., the input name 724) an image file 174 (e.g., the “standard-output” value 728) from the first CAD tool 118 after the “application part” 706 is generated.

Each input element 712, 714, 716, 718, and 720 may also have a minvalue 730 and a maxvalue 732, identifyinglower limit and an upper limit, respectively, for the value 728.

Turning to FIG. 2C, the image viewer 154 next determines whether there is a group of input element(s) identified in the configuration file for the selected CAD Application (step 230). Continuing with the example configuration file 700, the image viewer 154 is able to identify the group 710 in the configuration file 700 corresponding the object model selection 604 associated with the selected CAD application 120A.

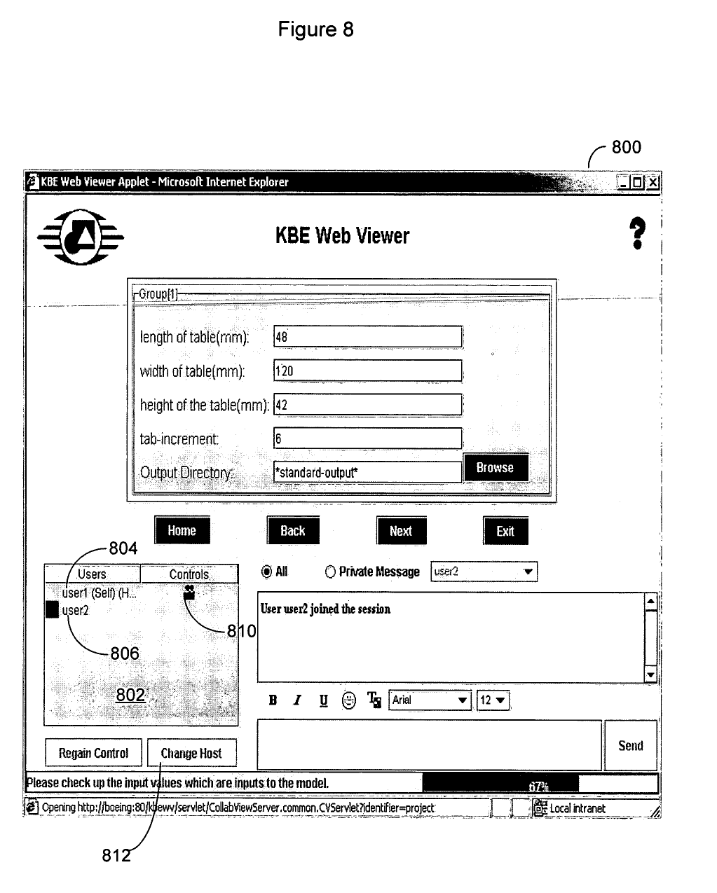

If there is a group of input element(s) identified in the configuration file, the image viewer 154 displays a name (step 230) and a value (step 232) associated with each input element in the group. FIG. 8 depicts an exemplary user interface 800 generated by the image viewer 154 to display the name 724 and default value 728 for each input element 712, 714, 716, 718, and 720 identified in the configuration file 700. As shown in FIG. 8, the image viewer 154 also may display in a panel 802 an identification of each user 804 and 806 operating on a respective client computer system 104 or 106 that has joined the present work session as communicated by the image server 142. The image viewer 154 also displays a master indicator 810 in association with one of the users 804 and 806 to reflect which user is the master of (i.e., in control of) the work session. As previously described, the image server 142 manages each joint work session via the collaboration server 166 such that the user interface 800 displayed on the client computer system 104 where the user 804 is acting as the master of the work session is pipelined or communicated to another user 806 operating on another client computer system 106. In the implementation shown in FIG. 8, the image viewer 154 allows the user 804 acting as the master of the work session to change the value 712 of an input element 712 (e.g., “length of table” dimension) in the configuration file 700 before the image viewer 154 requests the image server 142 to cause first CAD tool 118 to generate the application part 702 (e.g., “table-with-mats”) using the configuration file 700. The image viewer 154 also allows the user 804 to select a control button 812 to transfer control or “change host” of the work session (e.g., change input control of user interface 800) to another user 806 acting as a slave of the work session while operating on another client computer system 106.

Returning to FIG. 2C, the image viewer 154 determines whether the value 724 for any input element 712, 714, 716, 718, or 720 has been changed by the user (step 234). If the value for an input element has not been changed, the image viewer 154 continues processing at step 240. If the value for an input element has been changed, the image viewer 154 modifies the configuration file 700 to reflect the changed value (step 238).

The image viewer 154 then determines whether there are more groups of input elements in the configuration file (step 240). If there are more groups of input elements in the configuration file, the image viewer 154 identifies the next group of input elements in the configuration file (step 242) and then continues processing at step 232. In the example shown in FIG. 7, the image viewer 154 is able to recognize there are no more groups of input elements following the group 710.

Turning to FIG. 2D, if there are no more groups of input elements in the configuration file, the image viewer 154 prompts the image server 142 to load the first CAD tool with the CAD application associated with the configuration file (step 244). In the implementation shown in FIG. 8, the user 804 or 806 in control of the user interface may select another button 814 (e.g., “next” button) to cause the image viewer 154 to transmit the configuration file 700 to the image server 142 via the web server 152. After receiving the configuration file 700, the image viewer 154 identifies the application path 704 in the configuration file 700 and commands the first CAD tool 118, via the first CAD server 144 and the first CAD launcher server 148, to load and run the CAD Application 120A located at the application path 704.

The image server 142 then determines whether there is an input element in the configuration file (246). If there is no input element in the configuration file, the image server 142 commands the first CAD tool, via the first CAD server 144 and the first CAD launcher server 148, to generate an object model associated with the CAD application (step 248). If there is an input element in the configuration file, the image server 142 commands the first CAD tool, via the first CAD server 144 and the first CAD launcher server 148, to generate an object model associated with the CAD application based on the input element identified in the configuration file (step 250). Continuing with the exemplary configuration file 700, the image server 142 commands the first CAD tool to generate the object model corresponding to the application part 702 (e.g., “table-with-mats”) previously been defined using the CAD Application 120A (e.g., “table.lisp”) at a location on the network 108 specified by the application path 704.

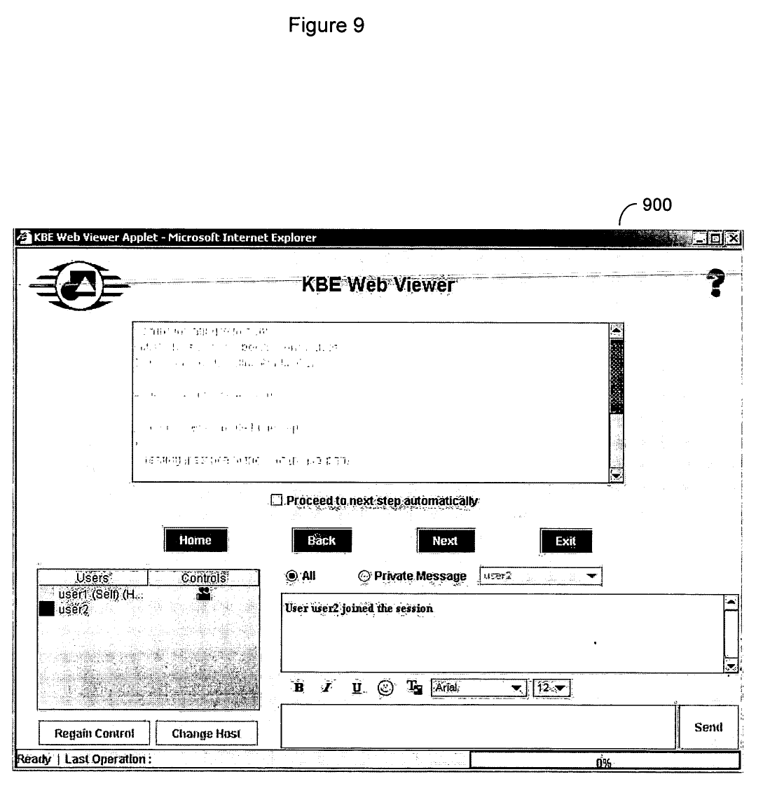

In one implementation, the image server 142 communicates the first CAD tool's progress 902 to the image viewer 154 running on each of the client computer systems 104 and 106 participating in the work session. FIG. 9 depicts an exemplary user interface 900 generated by the image viewer 154 to allow the user 804 and 806 participating in the work session to monitor the first CAD tool's progress 902 in loading the selected CAD application and generating the object model of the application part specified in the configuration file 700.

In response to the command to generate an object model, the image server 142 receives from the first CAD tool, via the first CAD launcher server 148 and the first CAD server 144, a tree of subparts or elements defining the object model for the application part (step 252). The image server 142 communicates the tree, which may be a list or hierarchical structure, to the image viewer 154 running on each of the client computer systems 104 and 106 participating in the work session.

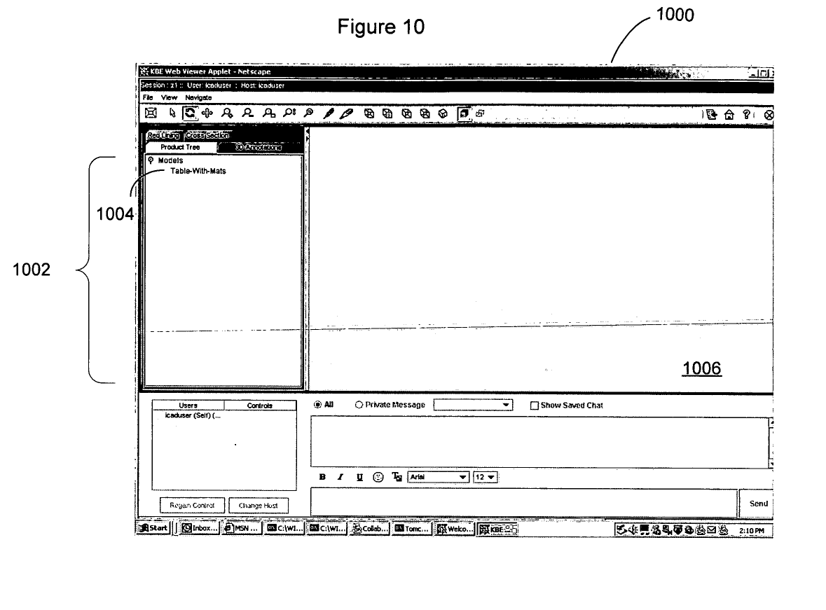

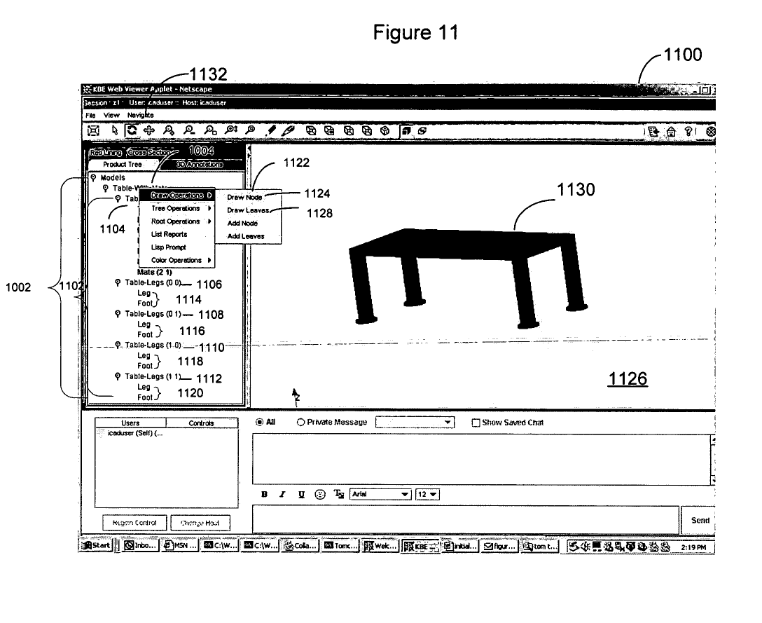

The image viewer 154 then displays the tree of subparts or elements (step 254). For example, FIG. 10 depicts a user interface 1000 generated by the image viewer 142 to display the tree 1002 or hierarchical structure of elements 1102 in FIG. 11 defining the application part object model 1004 (e.g., identified as “table-with-mats”) generated by and received from the first CAD tool in accordance with methods consistent with the present invention. FIG. 11 depicts an exemplary user interface 1100 generated by the image viewer 154 to allow users to selectively request to view geometry of the application part object model 1004 or one of its elements 1102. In the implementation shown in FIGS. 10 and 11, the application part object model 1004 represents the root node of the tree 1002 and the elements 1102 includes nodes 1104, 1106, 1108, 1110, and 1112. Each node may include one or more leaves (leaves for node 1104 not in view in FIG. 11), 1114, 1116, 1118, and 1120 associated with the respective node.

Turning to FIG. 2E, the image viewer 154 next determines whether a request to generate geometry has been received (step 256). The image viewer 154 allows the user to select a node 1004, 1104, 1106, 1108, 1110, or 1112, or one of the leaves 1114, 1116, 1118, or 1120 and then request via a drop down menu 1122 (or other input technique) geometry of the selected node and its leaves (e.g., “draw node” 1124 request) be generated for view in panel 1006 or 1126. Alternatively, the image viewer 154 may allow the user to select a node 1104, 1106, 1108, 1110, and 1112 and then request that geometry of leaves of the selected node (e.g., “draw leaves” 1128 request) be generated for view in panel 1126.

If a request to generate geometry has not been received, the image viewer may end processing or wait until an “exit” request is received. If a request to generate geometry has been received, the imager viewer 154 commands the first CAD tool to generate geometry of the object model (e.g., node 1004) or an element of the object model (e.g., node 1106) in accordance with the received request (step 258). In one implementation, the image viewer 154 communicates the received request to the image viewer 142, which then submits a corresponding command to the first CAD tool, via a script file 170 or known application program interface for the first CAD tool 118. In response, the image server 142 receives an image file 174 from the first CAD tool 118 reflecting the requested geometry of the object model (e.g., node 1004). The image file 174 may be a standard exchange geometric file configured in a standard format, such as a stereolithography format (STL), listing the triangular (or other equivalent structure) surfaces, elements, or volumes describing the geometry of an object model.

The image server 142 then receives an image file (e.g., image file 174) from the first CAD tool 118 describing the geometry of the object model or the element (step 260) and generates a representative object model (e.g., model 167A) from the image file 174 (step 262). The image server 142 is able to generate a representative object model using standard CAD transformation techniques for generating a facetted boundary solid model representation from a standard geometric file, such as an STL file. In one implementation, the image server 142 may transfer the image file 174 or the representative object model 167A to the image viewer 154 running on each client computer system 104 and 106 participating in the respective work session. In this implementation, the image viewer 154 acting as the master of the work session (e.g., the image viewer running on the client computer system 104) is able to manipulate (e.g., rotate or translate) the representative object model 167A without accessing the corresponding object model generated by the first CAD tool 118. The image server 142 communicates changes to the representative object model 167A from the image viewer 154 acting as the master of the work session to other image servers 154 on other client computer systems participating in the work session. Alternatively, the image server 142 may maintain the representative object model 167A. In this implementation, the image server 142 manipulates the representative object model 167A as requested by the image viewer 154 acting as the master of the work session and communicates corresponding changes (or modified representative object model 167A) to the client computer systems 104 and 106 participating in the work session.

Next, the image viewer 154 displays the geometry of the representative object model (e.g., node 1004) or the element of the object model (e.g., node 1108) in accordance with the request (step 264). As shown in FIG. 11, the image viewer 154 running on each client computer system 104 and 106 participating in the respective work session displays the geometry 1130 associated with the application part object model (identified as “Table-With-Mats” in FIG. 11) in response to the selection of node 1004 by the user 804 operating as the master of the work session on client computer system 104. The image viewer 154 then continues processing at step 274 in FIG. 2F.

If the object model selection does not correspond to a CAD Application in step 226, the image viewer 154 recognizes that the object model selection corresponds to an object model 124A-N generated by the second CAD tool 122 and commands the second CAD tool to generate geometry of the object model associated with the object model selection (step 266) via the image server 142. In response, the image server 142 receives an image file 176 from the second CAD tool 118 describing the geometry of the selected object model (step 268) and generates a representative object model from the image file (step 270). The image file 176 is also configured in a standard format, such as an STL format, interpretable by the image server 142 to generate the representative object model (e.g., model 167B) in accordance with methods and systems consistent with the present invention.

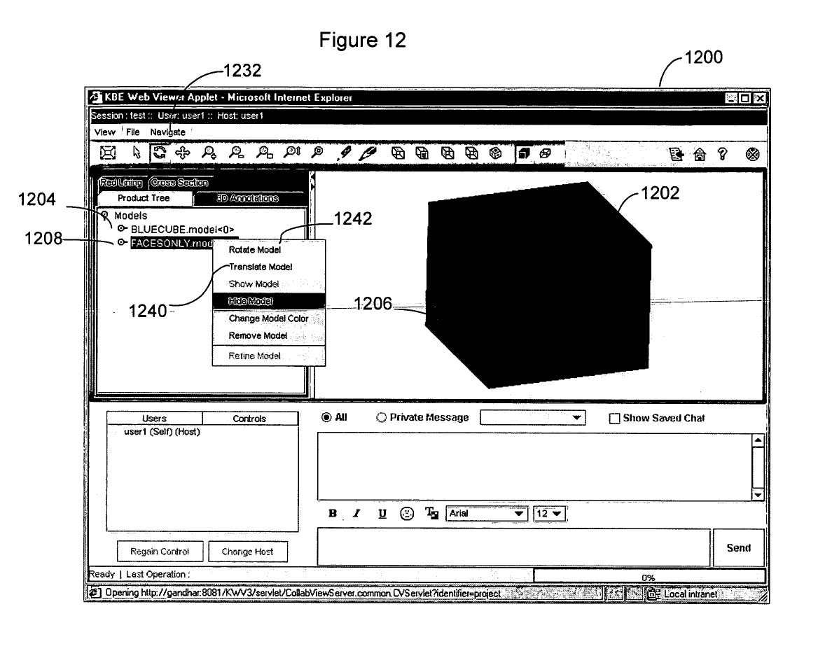

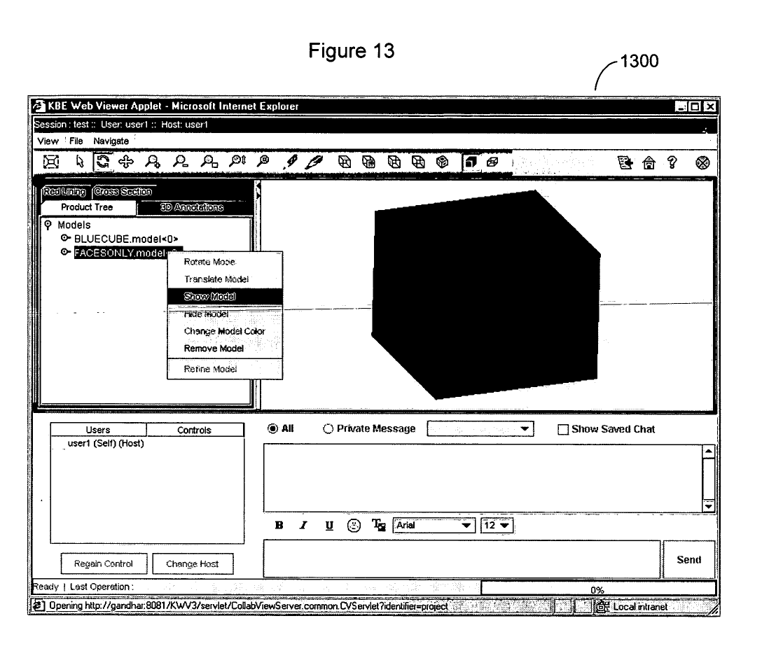

Next, the image viewer 154 running on each client computer system 104 and 106 participating in the respective work session displays the geometry associated with the selected object model (step 272). In one implementation, the image server 142 communicates the representative object model 167B to the image viewer 154 running on each client computer system 104 and 106 participating in the work session so each image viewer 154 displays the same geometry associated with the selected object model. FIG. 12 depicts an exemplary user interface 1200 generated by the image viewer 142 to display the geometry 1202 of the object model 120A associated with and identified by the object model selection 1204, “Bluecube.model.” Users may choose multiple object model selections 506 in FIG. 5 such that respective geometry of each object model selection 506 may be displayed simultaneously on each of the client computer systems 104 and 106 participating in the work session. Accordingly, the image viewer 154 displays the geometry 1206 of the object model 120B associated with and identified by the object model selection 1208, “Facesonly.model.”

The image viewer 154 then determines whether a request has been received to access another object model (step 274). If another request has been received to access another object model, the image viewer 154 continues processing at step 220. In one implementation, the image viewer 154 allows the user acting as the master of the work session to select a navigate button 1132 in FIG. 11 or 1232 in FIG. 12 to signal the image viewer 154 to display the user interface 500 so another object model selection may be chosen.

If a request has not been received to access another model, the image viewer 154 displays one or more options for manipulating the object model to change the geometry in view (step 276) and then determines whether one of the manipulation options has been selected (step 278). The image viewer 154 then modifies the representative object model (e.g., models 167B and 167C) in accordance with the manipulation option (step 272). For example, as shown in FIG. 12, the image viewer 142 generates and displays the menu 1240 to allow users to select the manipulation option 1242 to rotate the representative object model 167B and 167C, individually or collectively, corresponding to the geometry in view (e.g., geometry 1202 and 1206). In one implementation, the image viewer 142 communicates the manipulation option (e.g., rotate option 1242) to the image server 142 to process. In this implementation, the image server 142 may rotate the geometry 1202 and 1206 by a pre-determined increment (e.g., 90 degrees) about a center axis of the geometry 1202 and 1206. Alternatively, the image server 142 may rotate about an axis identified by the user as explained in reference to rotating a cross section below. The image viewer 154 in combination with the image server 142 is configured to perform other standard manipulations, such as zoom, pan, or rotate to display a requested view (e.g., front, top, left, or right) of the representative object model (e.g., models 167A and 167B) with geometry 1202 and 1206 currently displayed.

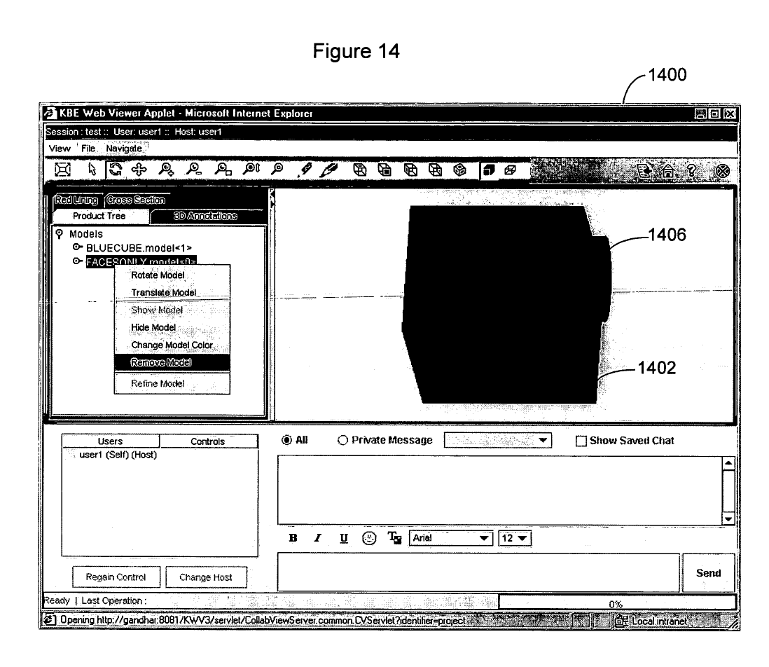

Next, the image viewer 154 running on each client computer system 104 and 106 participating in the respective work session displays the geometry of the modified representative object model (step 282). FIG. 14 depicts a user interface 1400 generated by the image viewer 154 to display the geometry 1402 and 1406 of the modified representative object models 167B and 167C, which were rotated by 90 degrees along the center axis of the geometry 1202 and 1206 shown in FIG. 12.

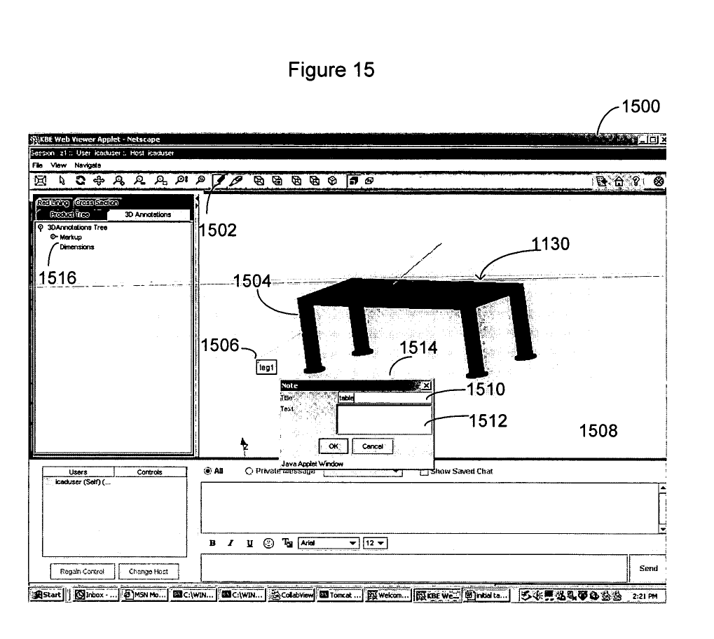

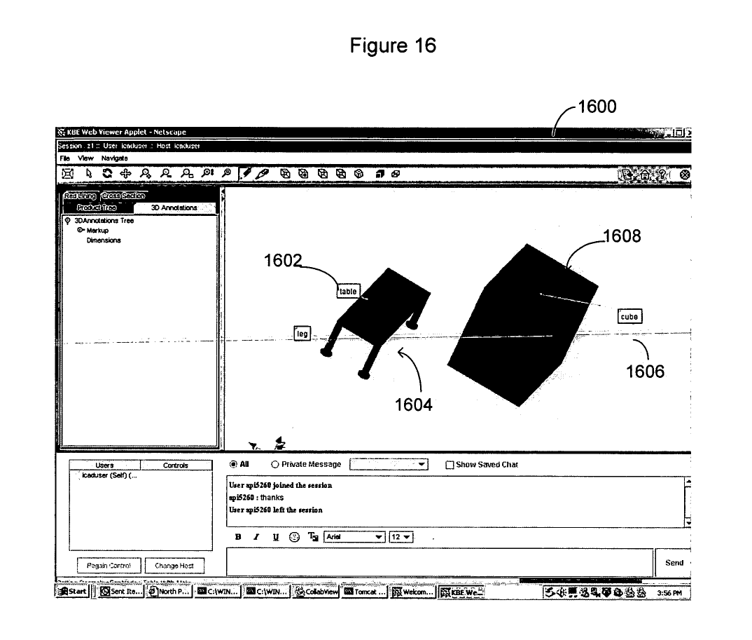

After displaying the geometry of the selected object model or if one of the options to manipulate the object model has not been selected in step 270, the image viewer determines whether a request to create a markup has been received (step 284 in FIG. 2G). FIG. 15 depicts an exemplary user interface 1500 generated by the image viewer 154 to allow users to selectively markup geometry 1130 of the application part object model generated by the first CAD tool in FIG. 11. As shown in FIG. 15, the user may request to create a markup by mouse clicking the icon 1502 or using another input technique.

If a request to create a markup has been received, the image viewer 154 receives a point associated with the displayed geometry of the object model (step 286), receives a markup title (step 288), and receives a markup text associated with the markup title (step 290). In the implementation shown in FIG. 15, the user indicates to the image viewer 154 the point 1504 of the geometry 1130 by mouse clicking on the point 1504 and then dragging the mouse to another point 1506 in the panel 1508. The image viewer 154 displays the markup title 1510 or markup title 1512 received from the user, via dialog box 1514, at the other point 1506. The image viewer 154 then adds the markup title (e.g., title 1512) to an annotations tree (e.g., tree 1516) associated with the object model (step 292). Next, the image viewer 154 running on each client computer system participating in the work session displays the markup title (e.g., title 1510) or text (e.g., 1512) at the point associated with the geometry of the object model (step 294).

In accordance with methods consistent with the present invention, the image viewer 154 allows the user to create and associate a first markup (e.g., markup title 1602) with geometry 1604 of an object model 167A generated by the first CAD tool and to create and associate a second markup (e.g., markup title 1606) with geometry 1608 of another object model 167B generated by the second CAD tool.

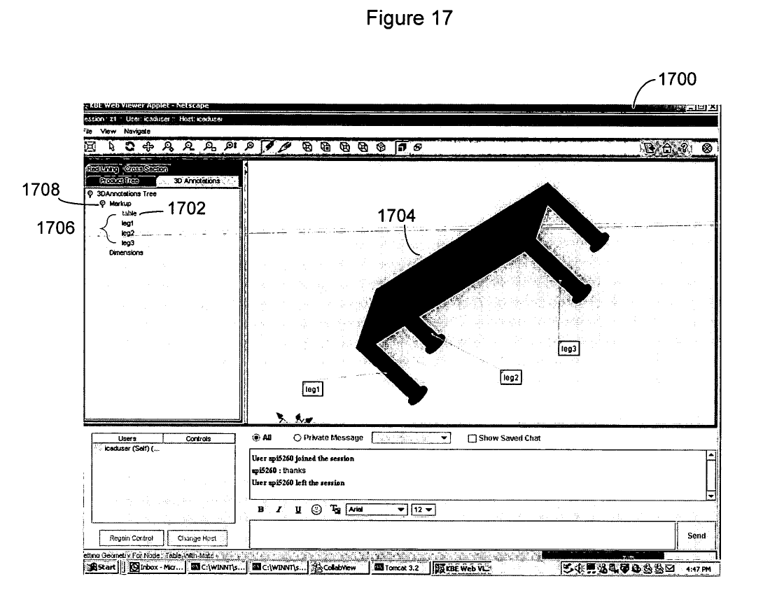

After one or more markups are associated with the geometry of the object model in accordance methods and systems consistent with the present invention, the image viewer 154 determines whether a request to hide a markup has been received (step 296). The image viewer 154 then displays each markup title in the annotations tree associated with the object model (step 298) and receives a selected markup title in the annotations tree (step 300). FIG. 17 depicts an exemplary user interface 1700 generated by the image viewer 154 to allow users to hide a previously displayed markup (e.g., “table” 1702) of the geometry 1704 of the object model. In the implementation shown in FIG. 17, the user may request to hide a markup by selecting the markup 1702 to hide from among the markups 1706 listed by the image viewer 154 in the markup annotation tree 1708. After the markup to hide has been identified by the user, the image viewer 154 removes the markup text associated with the selected markup title from the display on each client computer system participating in the working session (step 302).

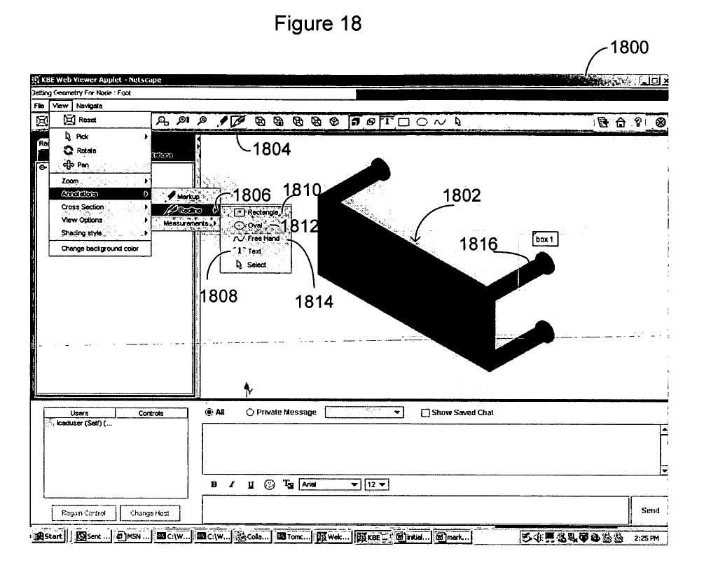

After removing the markup text or if a request to hide a markup has not been received or if a request to create a markup has not been received, the image viewer determines whether a request to create a redline has been received (step 304 in FIG. 2H). FIG. 18 depicts an exemplary user interface 1800 generated by the image viewer 154 to allow users to selectively redline geometry 1802 of an application part object model generated by the first CAD tool. As shown in FIG. 18, the image viewer 154 allows the user to request to create a redline via an icon selection 1804 or menu selection 1806. If a request to create a redline has been received, the image viewer 154 then receives a redline type, such as a text type 1808, a rectangle type 1810, an oval type 1812, or freeform type 1814 (step 306). The image viewer 154 then receives an indication of a portion 1816 of the displayed geometry of the representative object model (step 308). The user may identify the portion 1816 to the image viewer 154 using a mouse click, drag and drop technique. The image viewer 154 then highlights the portion 1816 on the display of each client computer system participating in the working session in accordance with the received redline type, such as rectangle type 1810 (step 310).

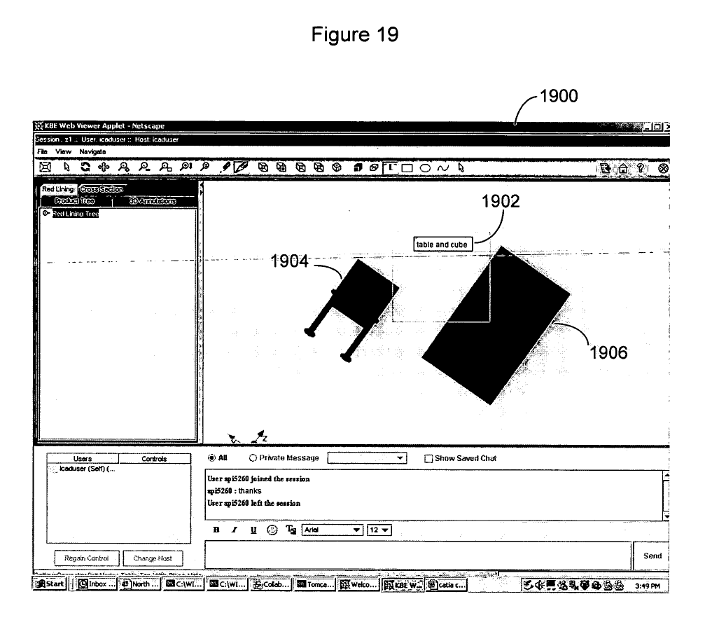

In accordance with methods consistent with the present invention, the image viewer 154 allows the user to create and associate a redline (e.g., “table and cube” redline 1902 in FIG. 19) with geometry 1904 of an object model 167A generated by the first CAD tool and with geometry 1906 of another object model 167B generated by the second CAD tool.

After highlighting the portion on the display or if a request to create a redline has not been received, the image viewer 154 determines whether the displayed geometry has been changed (step 312). If the displayed geometry has been changed, the image viewer 154 deletes the highlight of the portion from the display of each client computer system participating in the working session (step 314).

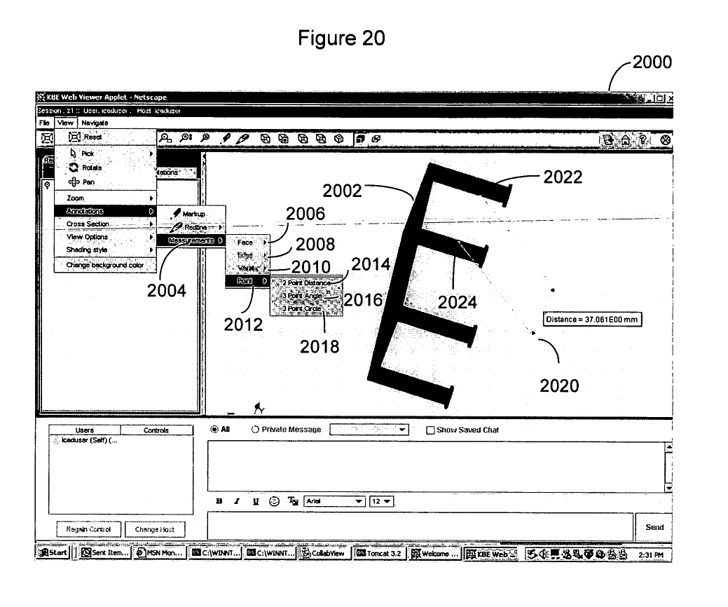

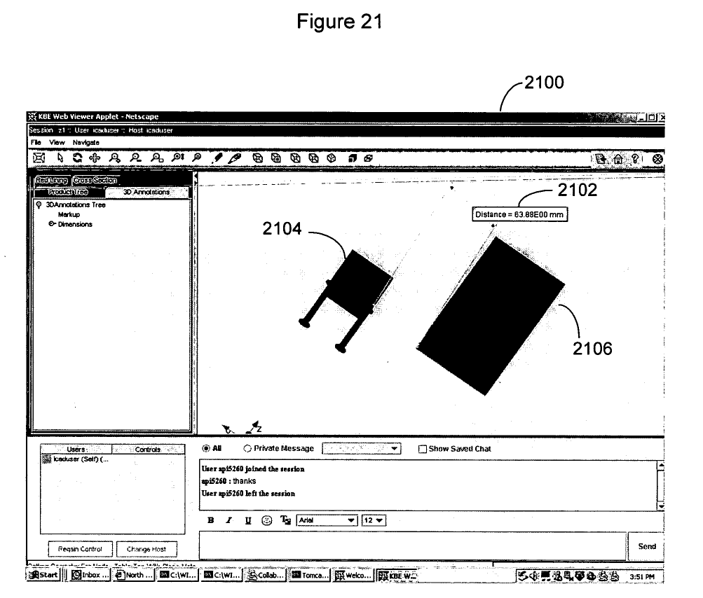

After deleting the highlight or if the displayed geometry has not been changed, the image viewer 154 determines whether a request to make a measurement has been received (step 316 in FIG. 21). If a request to make a measurement has been received, the image viewer 154 receives a selected dimension (e.g., face, edge, vertex, or point) of the object model to measure (step 318). FIG. 20 depicts an exemplary user interface 2000 generated by the image viewer 154 to allow users to selectively make a measurement of geometry 2002 of an application part object model generated by the first CAD tool. As shown in FIG. 20, the image viewer 154 allows the user to request to make a measurement via a drop-down menu selection 2004. The request to make a measurement may include a measurement type identified by the user, such as a face dimension 2006, an edge dimension 2008, and a vertex dimension 2010 or point dimension 2012. Selecting the face dimension 2006 type prompts the image viewer 154 to calculate the area of the selected dimension (e.g., a selected face) of the geometry 2002 of the object model. The edge dimension 2008 type prompts the image viewer 154 to identify the length or start and end coordinates of the selected dimension (e.g., a selected edge) of the geometry 2002 of the object model. The vertex dimension 2010 type prompts the image viewer 154 to identify coordinates of the selected dimension (e.g., a selected vertex) of the geometry 2002. The point dimension 2012 type may prompt the image viewer 154 to calculate the distance between the selected point dimension and another point identified by the user (e.g., menu option 2014 in FIG. 20), the angle formed by the selected point dimension and two vertices selected by the user (e.g., menu option 2016), or the radius of a circle formed by the selected point dimension and two points selected by the user (e.g., menu option 2018).

The image viewer 154 then receives a point (e.g., point 2020) associated with the displayed geometry of the object model (step 320). Next, the image viewer 154 identifies a measurement associated with the selected dimension in accordance with the request (step 322). In the example shown in FIG. 20, in accordance with the request to make a measurement between two points (e.g., menu option 2014), the image viewer 154 calculates the distance between the selected point dimension 2022 and another point 2024 identified by the user on the legs or geometry 2002 of the representative table model originally generated by the first CAD tool 118. The image viewer 154 then displays the measurement at the point 2020 associated with the geometry of the object model on each client computer system participating in the working session (step 324).

In accordance with methods consistent with the present invention, the image viewer 154 allows the user to make a measurement (e.g., distance 2102 in FIG. 21 in accordance with menu option 2014 for measuring the distance between two points) between geometry 2104 of an object model 167A generated by the first CAD tool and geometry 2106 of another object model 167B generated by the second CAD tool.

After displaying the measurement or if a request to make a measurement has not been received, the image viewer 154 determines whether a request to create a cross section has been received (step 326). If a request to create a cross section has been received, the image viewer 154 then receives an identification of a plane associated with the object model (step 328). The user may request to create a cross section by selecting a cross section option 2202 on the user interface 2200 generated by the image viewer 154. The user may then use a mouse click, drag and drop technique to identify the plane 2204 associated with the geometry 2206 of the representative object model.

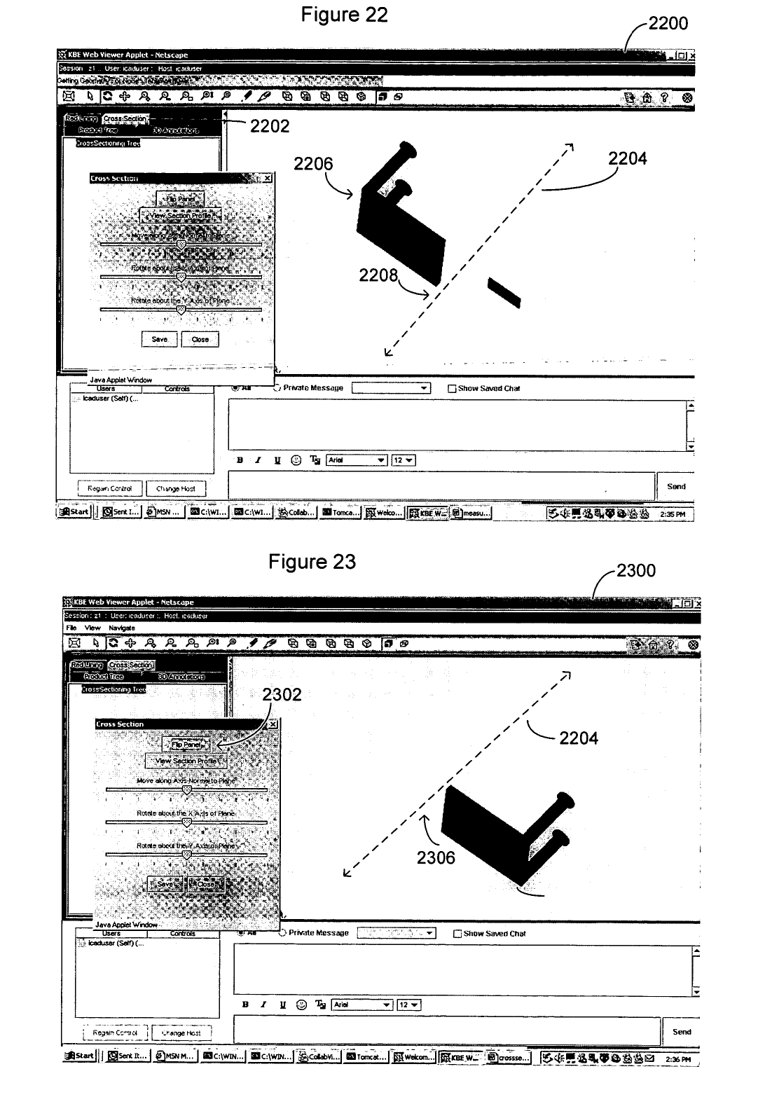

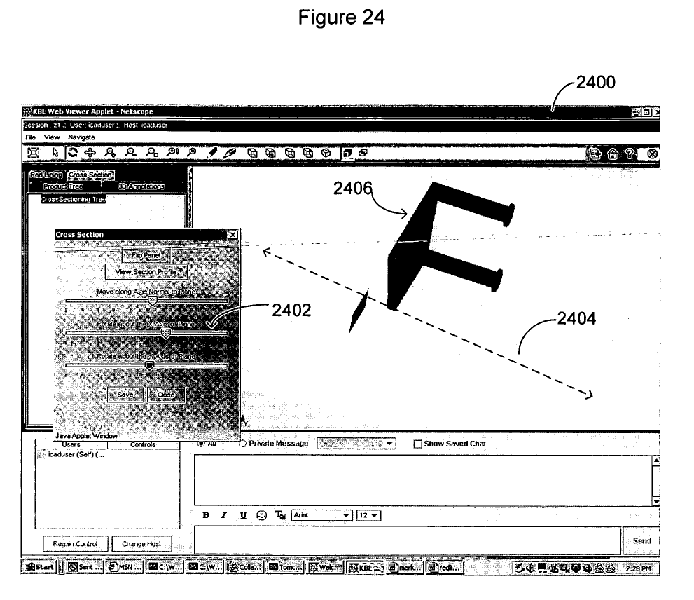

The image viewer 154 then generates geometry of a cross section of the representative object model along a first face (e.g., face 2208 in FIG. 22) of the plane (step 330) and displays the geometry of the cross section along the first face on each client computer system participating in the working session (step 332) as shown in FIG. 22.

Next, the image viewer 154 determines whether a request to flip the plane of the cross section has been received (step 334). The user may request to flip the plane of the cross section by selecting a flip panel option 2302 on the user interface 2300 generated by the image viewer 154. If a request to flip the plane of the cross section has been received, the image viewer 154 generates geometry of a cross section of the representative object model along a second face (e.g., 2306) of the plane (step 336) and displays the geometry of the cross section along the second face on each client computer system participating in the working session (step 338). Next, the image viewer 154 determines whether a request to rotate the cross section has been received (step 340).

If a request to rotate the cross section has been received, the image viewer 154 receives an identification of a first axis of the plane (step 342) and receives a rotation increment associated with the first axis (step 344). The image viewer 154 then rotates the representative object model about the first axis of the plane by the associated rotation increment (step 346). The image viewer then generates geometry of the cross section of the object model after the rotation (step 348) and displays the geometry of the cross section after rotation on each client computer system participating in the working session (step 350). Next, the image viewer 154 determines whether a request to rotate the cross section about a second axis has been received (step 352).

If a request to rotate the cross section about a second axis has been received, the image viewer 154 receives an identification of the second axis associated with the plane (step 354) and receives a rotation increment associated with the second axis (step 356). The image viewer 154 then rotates the representative object model about the second axis of the plane by the associated rotation increment (step 358). After rotating the representative object model, the image viewer 154 then generates geometry of the cross section of the rotated representative object model (step 360) and displays the geometry of the cross section after rotation on each client computer system participating in the working session (step 362). After displaying the geometry of the cross section after the second rotation or if a request to create or rotate a cross section is not received, the image viewer ends processing.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. Additionally, the described implementation includes software, such as the bus management tool, but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in a data processing system for viewing geometry of an object model generated by a first computer-aided design (CAD) tool hosted on a server computer system on a network, the data processing system having a client computer system connected via the network to the server computer system, the method comprising:
receiving, via the client computer system on the network, an object model selection associated with the first CAD tool;
providing the first CAD tool with an ICAD application associated with the object model selection;
commanding the first CAD tool to generate an object model using the ICAD application, the object model having at least one element;
displaying on the client computer system a structure identifying the at least one element of the object model;
receiving a request, via the client computer system, to view a selected one of the at least one elements;
commanding the first CAD tool to generate an image file describing geometry of the selected element in response to the request to view the selected element; and
displaying the geometry of the selected element on the client computer system in accordance with the image file.

2. A method of claim 1, the step of providing the first CAD tool with an ICAD application further comprises:
identifying a configuration file corresponding to the object model selection;
determining whether the configuration file has an input associated with the object model;
when it is determined that the configuration file has an input associated with the object model,
receiving, via the client computer system, a value for the input; and
modifying the configuration file to include the value for the input,
wherein the step of commanding the first CAD tool to generate an object model using the ICAD application further comprises providing the first CAD tool with the value for the input such that the object model is generated by the first CAD tool using the input value.

3. A method of claim 2, wherein the data processing system has an image server operatively connected between the client computer system and the first CAD tool on the network, the image server being operatively configured to perform the step of providing the first CAD tool with an ICAD application.

4. A method of claim 3, wherein the step of providing the first CAD tool with an ICAD application further comprises identifying in the configuration file an application path corresponding to a location on the network where the ICAD application is stored.

5. A method of claim 1, wherein the client computer system is a first of a plurality of client computer systems connected via the network to the server computer system, the method further comprising displaying the geometry of the selected element on a second of the plurality of client computer systems in response to receiving the request to view the selected element from the first client computer system.

6. A method of claim 5, further comprising:
creating a work session associated with the first client computer system and the first CAD tool;
receiving a request, via the second client computer system, to participate in the work session; and
displaying on the second client computer system the geometry of the selected element in response to determining that the second client computer system is participating in the work session.

7. A method of claim 6, further comprising:
generating a representative object model from the image file; and
providing the representative object model to each client computer system participating in the work session, wherein each of the client computer systems participating in the work session displays the geometry of the selected element in accordance with the representative object model.

8. A method of claim 6, further comprising:
receiving a request to markup the displayed geometry of the selected element;
receiving, via the first client computer system, a point associated with the displayed geometry;
receiving text to associate with the markup;
displaying on each of the client computer systems participating in the work session the text in relation to the point associated with the displayed geometry.

9. A method of claim 6, further comprising:
receiving a request to redline the displayed geometry of the selected element;
receiving a redline type;
receiving, via the first client computer system, an indication of a portion of the displayed geometry;
highlighting on each of the client computer systems participating in the work session the portion of the displayed geometry in accordance with the redline type.

10. A method of claim 9, wherein the redline type is one of a rectangle type, an oval type, a freeform type, and a text type.

11. A method of claim 6, further comprising:
receiving a request to make a measurement;
receiving a selected dimension of the object model to measure;
receiving a first point associated with the displayed geometry;
identifying the measurement associated with the selected dimension in accordance with the request; and
displaying the measurement on each of the client computer systems participating in the work session near the first point associated with the displayed geometry.

12. A method of claim 11, wherein the step of identifying the measurement further comprises calculating an area of a face associated with the selected dimension.

13. A method of claim 11, wherein the step of identifying the measurement further comprises determining a length of an edge associated with the selected dimension.

14. A method of claim 11, wherein the step of identifying the measurement further comprises determining one or more coordinates of a vertex associated with the selected dimension.

15. A method of claim 11, wherein the step of identifying the measurement further comprises:
receiving a second point associated with the displayed geometry; and
determining a distance between the second point and a third point associated with the selected dimension.

16. A method of claim 11, wherein the step of identifying the measurement further comprises:
receiving a plurality of vertices associated with the displayed geometry; and
determining an angle formed by the plurality of vertices and another vertice associated with the selected dimension.

17. A method of claim 11, wherein the step of identifying the measurement further comprises:
receiving a plurality of points associated with the displayed geometry; and
determining a radius of a circle formed by the plurality of points and a second point associated with the selected dimension.

18. A method of claim 6, further comprising:
receiving an identification of a plane associated with the object model;
generating geometry of a cross section of the representative object model along a first face of the plane; and
displaying the geometry of the cross section along the first face on each client computer system participating in the working session.

19. A method of claim 18, further comprising:
determining whether a request to flip the plane of the cross section has been received;
when it is determined that a request to flip the plane of the cross section has been received,
generating geometry of another cross section of the representative object model along a second face of the plane; and
displaying the geometry of the other cross section along the second face on each client computer system participating in the working session.

20. A method of claim 18, further comprising:
determining whether a request to rotate the cross section has been received;
when it is determined that a request to rotate the cross section has been received, receiving a first axis of the plane;
receiving a rotation increment associated with the first axis;
rotating the representative object model about the first axis of the plane by the associated rotation increment;
generating geometry of the cross section of the object model after the rotation; and
displaying the geometry of the cross section after rotation on each client computer system participating in the working session.

21. A method of claim 1, wherein the data processing system includes a second CAD tool operatively connected to the network, the method further comprising:
determining whether the object model selection corresponds to the ICAD application;
when it is determined that the object model selection does not correspond to the ICAD application,
commanding the second CAD tool to generate another image file describing geometry of a second object model corresponding to the object model selection;
generating a second representative object model from the other image file; and
providing the second representative object model to the client computer system, wherein the client computer system displays geometry of the second representative object model.

22. A method of claim 21, wherein the second object model is a pre-existing solid model generated by the second CAD tool.

23. A method of claim 21, wherein the data processing system has an image server operatively connected between the client computer system and each of the CAD tools on the network, the image server being operatively configured to perform the step of generating a second representative object model from the other image file, and providing the second representative object model to the client computer system.

24. A method of claim 23, wherein the client computer system is a first of a plurality of client computer systems connected via the network to the image server, the method further comprising:
creating a work session associated with the first client computer system and the first CAD tool;
receiving a request, via the second client computer system, to participate in the work session;
displaying on the second client computer system the geometry of the selected element and the geometry of the second representative object model in response to determining that the second client computer system is participating in the work session.

25. A method of claim 24, further comprising:
receiving, via the first client computer system, a first point associated with the displayed geometry of the selected element;
receiving a first text;
receiving, via the first client computer system, a second point associated with the displayed geometry of the second representative object model;
receiving a second text;
displaying on each of the client computer systems participating in the work session the first text in relation to the first point associated with the displayed geometry of the selected element and the second text in relation to the second point associated with the displayed geometry of the second representative object model.

26. A method of claim 24, further comprising:
receiving a request to redline;
receiving a redline type;
receiving, via the first client computer system, an indication of a first portion of the displayed geometry of the selected element and a second portion of the displayed geometry of the second representative object model; and
highlighting on each of the client computer systems participating in the work session the first portion and the second portion in accordance with the redline type.

27. A method of claim 24, further comprising:
receiving a request to make a measurement;
receiving a first dimension associated with the displayed geometry of the selected element;
receiving a second dimension associated with the displayed geometry of the second representative object model;
receiving a first point associated with the displayed geometry of the selected element and the displayed geometry of the second representative object model;
identifying the measurement associated with the first and second dimensions in accordance with the request; and
displaying the measurement on each of the client computer systems participating in the work session near the first point.

28. A method of claim 27, wherein the step of identifying the measurement further comprises determining a distance between the first and second dimensions.

29. A data processing system, comprising:
a plurality of client computer systems operatively connected to a network;
a first server computer system operatively connected to the network and having a first CAD tool;
means for receiving, via a first of the client computer systems, an object model selection associated with the first CAD tool;
means for providing the first CAD tool with an ICAD application associated with the object model selection;
means for commanding the first CAD tool to generate an object model using the ICAD application, the object model having at least one element;
means for displaying, on the first client computer system, a structure identifying the at least one element of the object model;
means for receiving a request, via the first client computer system, to view a selected one of the at least one element;
means for commanding the first CAD tool to generate an image file describing geometry of the selected element in response to the request to view the selected element; and
means for displaying the geometry of the selected element on the first client computer system in accordance with the image file.

30. A data processing system of claim 29, wherein the means for providing the first CAD tool with an ICAD application comprises:
means for identifying a configuration file corresponding to the object model selection;
means for determining whether the configuration file has an input associated with the object model;
means for, when it is determined that the configuration file has an input associated with the object model, receiving, via the client computer system, a value for the input, modifying the configuration file to include the value for the input, and providing the first CAD tool with the value such that the object model is generated by the first CAD tool using the input value.

31. A data processing system of claim 29, wherein the client computer system is a first of a plurality of client computer systems operatively connected to the network and the means for displaying the geometry of the selected element further includes means for displaying the geometry of the selected element on a second of the plurality of client computer systems in response to receiving the request to view the selected element from the first client computer system.

32. A data processing system of claim 31, further comprising:
means for creating a work session associated with the first client computer system and the first CAD tool; and
means for receiving a request, via the second client computer system, to participate in the work session,
wherein the means for displaying the geometry of the selected element on the first computer system further includes means for displaying the geometry of the selected element on the second computer system in response to determining that the second client computer system is participating in the work session.

33. A data processing system of claim 32, further comprising:
means for generating a representative object model from the image file, wherein the means for displaying the geometry of the selected element on the first and the second computer systems further includes means for providing the representative object model to each client computer system participating in the work session such that each of the client computer systems participating in the work session displays the geometry of the selected element in accordance with the representative object model.

34. A data processing system of claim 32, further comprising:
means for receiving a request to markup the displayed geometry of the selected element;
means for receiving, via the first client computer system, a point associated with the displayed geometry;
means for receiving text to associate with the markup;
means for displaying on each of the client computer systems participating in the work session the text in relation to the point associated with the displayed geometry.

35. A data processing system of claim 32, further comprising:
means for receiving a request to redline the displayed geometry of the selected element;
means for receiving a redline type;
means for receiving, via the first client computer system, an indication of a portion of the displayed geometry;
means for highlighting on each of the client computer systems participating in the work session the portion of the displayed geometry in accordance with the redline type.

36. A data processing system of claim 32, further comprising:
means for receiving a request to make a measurement;
means for receiving a selected dimension of the object model to measure;
means for receiving a first point associated with the displayed geometry;
means for identifying the measurement associated with the selected dimension in accordance with the request; and
means for displaying the measurement on each of the client computer systems participating in the work session near the first point associated with the displayed geometry.

37. A data processing system of claim 36, wherein the means for identifying the measurement further comprises means for calculating an area of a face associated with the selected dimension.

38. A data processing system of claim 36, wherein the means for identifying the measurement further comprises means for determining a length of an edge associated with the selected dimension.

39. A data processing system of claim 36, wherein the step of identifying the measurement further comprises means for determining one or more coordinates of a vertex associated with the selected dimension.

40. A data processing system of claim 36, wherein the means for identifying the measurement further comprises:
means for receiving a second point associated with the displayed geometry; and
means for determining a distance between the second point and a third point associated with the selected dimension.

41. A data processing system of claim 36, wherein the means for identifying the measurement further comprises:
means for receiving a plurality of vertices associated with the displayed geometry; and
means for determining an angle formed by the plurality of vertices and another vertice associated with the selected dimension.

42. A data processing system of claim 36, wherein the means for identifying the measurement further comprises:
means for receiving a plurality of points associated with the displayed geometry; and
means for determining a radius of a circle formed by the plurality of points and a second point associated with the selected dimension.

43. A data processing system of claim 32, further comprising:
means for receiving an identification of a plane associated with the object model;
means for generating geometry of a cross section of the representative object model along a first face of the plane; and
means for displaying the geometry of the cross section along the first face on each client computer system participating in the working session.

44. A data processing system of claim 43, further comprising:
means for determining whether a request to flip the plane of the cross section has been received;
means for, when it is determined that a request to flip the plane of the cross section has been received, generating geometry of another cross section of the representative object model along a second face of the plane; and displaying the geometry of the other cross section along the second face on each client computer system participating in the working session.

45. A data processing system of claim 43, further comprising:
means for determining whether a request to rotate the cross section has been received; and
means for, when it is determined that a request to rotate the cross section has been received, receiving a first axis of the plane; receiving a rotation increment associated with the first axis, rotating the representative object model about the first axis of the plane by the associated rotation increment, generating geometry of the cross section of the object model after the rotation, and displaying the geometry of the cross section after rotation on each client computer system participating in the working session.

46. A data processing system of claim 29, further comprising
a second CAD tool operatively connected to the network;
means for determining whether the object model selection corresponds to the ICAD application; and
means for, when it is determined that the object model selection does not correspond to the ICAD application, commanding the second CAD tool to generate another image file describing geometry of a second object model corresponding to the object model selection, generating a second representative object model from the other image file, and providing the second representative object model to the client computer system such that the client computer system displays geometry of the second representative object model.

47. A data processing system of claim 46, wherein the client computer system is a first of a plurality of client computer operatively connected to the network, the data processing system further comprising:
means for creating a work session associated with the first client computer system and the first CAD tool;
means for receiving a request, via the second client computer system, to participate in the work session;
means for displaying on the second client computer system the geometry of the selected element and the geometry of the second representative object model in response to determining that the second client computer system is participating in the work session.

48. A data processing system of claim 47, further comprising:
means for receiving, via the first client computer system, a first point associated with the displayed geometry of the selected element;
means for receiving a first text;
means for receiving, via the first client computer system, a second point associated with the displayed geometry of the second representative object model;
means for receiving a second text;
means for displaying on each of the client computer systems participating in the work session the first text in relation to the first point associated with the displayed geometry of the selected element and the second text in relation to the second point associated with the displayed geometry of the second representative object model.

49. A data processing system of claim 47, further comprising:
means for receiving a request to redline;
means for receiving a redline type;
means for receiving, via the first client computer system, an indication of a first portion of the displayed geometry of the selected element and a second portion of the displayed geometry of the second representative object model; and
means for highlighting on each of the client computer systems participating in the work session the first portion and the second portion in accordance with the redline type.

50. A data processing system of claim 47, further comprising:
means for receiving a request to make a measurement;
means for receiving a first dimension associated with the displayed geometry of the selected element;
means for receiving a second dimension associated with the displayed geometry of the second representative object model;
means for receiving a first point associated with the displayed geometry of the selected element and the displayed geometry of the second representative object model;
means for identifying the measurement associated with the first and second dimensions in accordance with the request; and
means for displaying the measurement on each of the client computer systems participating in the work session near the first point.

51. A data processing system of claim 27, wherein the means for identifying the measurement further comprises means for determining a distance between the first and second dimensions.

52. A data processing system, comprising:
a plurality of client computer systems operatively connected to a network, each client computer system having an image viewer;
a first server computer system operatively connected to the network and having a first CAD tool;
a memory having an image server program operatively connected, via the network, to the image viewer on each of the plurality of client computer systems and to the first CAD tool, the image server program receives, via a first of the client computer systems, an object model selection associated with the first CAD tool, provides the first CAD tool with an ICAD application stored on the network and associated with the object model selection, commands the first CAD tool to generate an object model having at least one element using the ICAD application, provides the image viewer on each of the client computer systems with a structure identifying the at least one element of the object model, receives a request, via the first client computer system, to view a selected one of the at least one element, commands the first CAD tool to generate an image file describing geometry of the selected element in response to the request to view the selected element, and causes the image viewer on each of the client computer systems to display the geometry of the selected element on the client computer system in accordance with the image file; and
a processor to run the image server program.

53. A data processing system of claim 52, further comprising
a second CAD tool operatively connected to the network,
wherein the image server program further determines whether the object model selection corresponds to the ICAD application, when it is determined that the object model selection does not correspond to the ICAD application, commands the second CAD tool to generate another image file describing geometry of a second object model corresponding to the object model selection, generates a second representative object model from the other image file, and provides the second representative object model to each of the client computer systems such that each client computer system displays geometry of the second representative object model.

54. A data processing system of claim 53, wherein the image viewer of the first computer system is operatively configured to receive text and a point associated with one of the displayed geometry of the selected element and the displayed geometry of the second representative object model in response to a request to markup displayed geometry, the image viewer of the first computer system is further operatively configured to provide the image server with the text and the point so that the image viewer on each of the client computer systems displays the text in relation to the point associated with the one displayed geometry.

55. A data processing system of claim 53, wherein the image viewer of the first computer system is operatively configured to receive a redline type and an indication of a first portion of the displayed geometry of the selected element and a second portion of the displayed geometry of the second representative object model in response to a redline request, the image viewer of the first computer system is further operatively configured to provide the image server with the redline type, the first portion, and the second portion so that the image viewer on each of the client computer systems highlights the first portion and the second portion in accordance with the redline type.

56. A data processing system of claim 53, wherein the image viewer of the first computer system is operatively configured to receive a first dimension associated with the displayed geometry of the selected element, and a second dimension associated with the displayed geometry of the second representative object model, the image viewer is further operatively configured to determine the measurement associated with the first and second dimensions in accordance with the request, and to provide the image server with the measurement, the first dimension, and the second dimension so that the image viewer on each of the client computer systems displays the measurement relative to the first dimension and the second dimension.

57. A data processing system of claim 56, wherein the means for identifying the measurement further comprises means for determining a distance between the first and second dimensions.

58. A computer-readable medium containing instructions that cause a data processing system having an image server program to perform a method, the data processing system having a plurality of client computer systems operatively connected to a network and a server computer system operatively connected to the network and having a CAD tool, the method comprising:
receiving, via a first of the client computer systems, an object model selection associated with the first CAD tool;
providing the first CAD tool with an ICAD application associated with the object model selection;
commanding the first CAD tool to generate an object model using the ICAD application, the object model having at least one element;
receiving a structure identifying the at least one element of the object model;
providing the structure to at least the first client computer system;
receiving a request to view a selected one of the at least one element;
commanding the first CAD tool to generate an image file describing geometry of the selected element in response to the request to view the selected element; and
providing one of the image files or a representative object model generated from the image file to each of the client computer systems so that each client computer system displays the geometry of the selected element in accordance with the image file.

59. A computer-readable medium of claim 52, wherein the data processing system further comprises a second CAD tool operatively connected to the network, and the method further comprises the steps of:
determining whether the object model selection corresponds to the ICAD application;
when it is determined that the object model selection does not correspond to the ICAD application,
commanding the second CAD tool to generate another image file describing geometry of a second object model corresponding to the object model selection;
generating a second representative object model from the other image file; and
providing the second representative object model to each of the client computer systems such that each client computer system displays geometry of the second representative object model.
